(19) United States
(12) Patent Application Publication
(10) Pub. No.: US 2026/0010854 A1
(43) Pub. Date: Jan. 8, 2026

(54) INFORMATION PROCESSING METHOD AND APPARATUS, EVALUATION PARAMETER OUTPUT APPARATUS, AND SYSTEM AND MEDIUM

(71) Applicants: BEIJING BOE TECHNOLOGY DEVELOPMENT CO., LTD., Beijing (CN); BOE Technology Group Co., Ltd., Beijing (CN)

(72) Inventor: Zhuohua Liu, Beijing (CN)

(73) Assignees: BEIJING BOE TECHNOLOGY DEVELOPMENT CO., LTD., Beijing (CN); BOE Technology Group Co., Ltd., Beijing (CN)

(21) Appl. No.: 18/992,795

(22) PCT Filed: Apr. 20, 2023
(86) PCT No.: PCT/CN2023/089383

§ 371 Date: Jan. 9, 2025

(51) Int. Cl. G06Q 10/0635; G06F 18/23213; G06Q 50/26

(52) U.S. Cl. CPC G06Q 10/0635; G06F 18/23213; G06Q 50/265

(57) ABSTRACT

An information processing method and apparatus, an evaluation parameter output apparatus, a system and a medium, which belong to the technical field of information processing. The method includes: acquiring a plurality of business information of a physical area in target business, the plurality of business information including at least information configured to describe states of different facilities in the physical area; clustering the plurality of business information according to a plurality of preset dimensions to obtain dimension information respectively corresponding to the plurality of preset dimensions; acquiring evaluation parameters respectively corresponding to the plurality of preset dimensions; and determining grading parameters of the physical area on the target business based on the plurality of evaluation parameters and the plurality of dimension information, the grading parameters being configured to indicate a grade to which the physical area belongs.

### TECHNICAL FIELD

The present disclosure relates to the technical field of information processing and more particularly, to an information processing method and apparatus, an evaluation parameter output apparatus, a system and a medium.

### BACKGROUND

In some scenarios, it is necessary to comprehensively manage and control a physical area. Generally speaking, the grades of the physical area in some business are regularly evaluated to manage and control the physical area based on evaluation results. This physical area may refer to a building area or a geographical area, while the business with grade evaluation may include fire safety evaluation business, medical safety evaluation business, people flow evaluation business, and the like.

For example, for the building area, it is necessary to continuously evaluate a fire safety performance of a building during the use of the building. If the building is a hospital, it is also necessary to evaluate a health defense performance of the hospital; and if the physical area is a scenic area, it is necessary to evaluate a safety protection performance of the scenic area for pedestrians in combination with a flow of people in the scenic area.

### SUMMARY

In a first aspect of the present disclosure, an information processing method is provided. The method includes:
acquiring a plurality of business information of a physical area on target business, the plurality of business information including at least information configured to describe states of different facilities in the physical area;
clustering the plurality of business information according to a plurality of preset dimensions to obtain a plurality of dimension information respectively corresponding to the plurality of preset dimensions;
acquiring a plurality of evaluation parameters respectively corresponding to the plurality of preset dimensions; and
determining grading parameters of the physical area on the target business based on the plurality of evaluation parameters and the plurality of dimension information, the grading parameters being configured to indicate a grade to which the physical area belongs.

In some optional embodiments, the acquiring a plurality of evaluation parameters respectively corresponding to the plurality of preset dimensions includes:
acquiring a plurality of evaluation factors respectively corresponding to the plurality of preset dimensions, and constructing an association relationship between the plurality of evaluation factors, wherein the association relationship includes a direct association relationship and an indirect association relationship;
determining an initial weight of each of the plurality of evaluation factors based on the association relationship; and
determining the plurality of evaluation parameters respectively corresponding to the plurality of preset dimensions based on the initial weights.

In some optional embodiments, the constructing an association relationship between the plurality of evaluation factors includes:
receiving an influence relationship inputted for the plurality of evaluation factors, wherein the influence relationship is configured to characterize a direct association between the plurality of evaluation factors; and
constructing the association relationship based on the influence relationship.

In some optional embodiments, the determining the plurality of evaluation parameters respectively corresponding to the plurality of preset dimensions based on the initial weights includes:
determining an influence parameter of a first evaluation factor on a second evaluation factor that has an association relationship with the first evaluation factor, wherein the influence parameter is configured to characterize an influence degree of the first evaluation factor on the second evaluation factor, and the first evaluation factor is any evaluation factor among the plurality of evaluation factors;
adjusting an initial weight of the second evaluation factor based on the influence parameter; and
determining the plurality of evaluation parameters respectively corresponding to the plurality of preset dimensions based on adjusted initial weights.

In some optional embodiments, the determining the plurality of evaluation parameters respectively corresponding to the plurality of preset dimensions based on the initial weights includes:
adjusting the initial weights of the plurality of evaluation factors in sequence, and when adjusting one evaluation factor each time, adjusting an initial weight of an evaluation factor that has an association relationship with the one evaluation factor based on a random number corresponding to the one evaluation factor;
repeating the step of sequentially adjusting the initial weights of the plurality of evaluation factors in a plurality of rounds to obtain the adjusted initial weights respectively corresponding to the plurality of evaluation factors in the plurality of rounds of adjustments; and
acquiring the plurality of evaluation parameters respectively corresponding to the plurality of preset dimensions based on the adjusted initial weights respectively corresponding to the plurality of evaluation factors in the plurality of rounds of adjustments.

In some optional embodiments, the adjusting an initial weight of an evaluation factor that has an association relationship with the one evaluation factor based on a random number corresponding to the one evaluation factor includes:
in a case that the initial weight of the evaluation factor is greater than the random number, adjusting the initial weight of the evaluation factor that has the association relationship with the one evaluation factor; and
in a case that the initial weight of the evaluation factor is not greater than the random number, retain the initial weight of the evaluation factor that has the association relationship with the one evaluation factor after a previous adjustment.

In some optional embodiments, the adjusting an initial weight of an evaluation factor that has an association relationship with the one evaluation factor based on a random number corresponding to the one evaluation factor includes:
determining an influence parameter of the one evaluation factor on the evaluation factor that has an association relationship with the one evaluation factor, wherein the influence parameter is configured to characterize an influence degree of occurrence of an event characterized by an evaluation factor on occurrence of an event characterized by another evaluation factor; and
adjusting the initial weight of the evaluation factor that has the association relationship with the one evaluation factor based on the influence parameter.

In some optional embodiments, the acquiring the plurality of evaluation parameters respectively corresponding to the plurality of preset dimensions based on the adjusted initial weights respectively corresponding to the plurality of evaluation factors in the plurality of rounds of adjustments includes:
constructing a cross-influence probability matrix based on the influence parameters between the evaluation factors that have the association relationship;
performing a plurality of iteration presetting operations on the cross-influence probability matrix and the adjusted initial weights respectively corresponding to the plurality of evaluation factors in the plurality of rounds of adjustments until a preset end condition is reached; and
acquiring the evaluation parameters respectively corresponding to the plurality of preset dimensions based on the cross-influence probability matrix when the preset end condition is reached.

In some optional embodiments, the determining grading parameters of the physical area on the target business based on the plurality of evaluation parameters and the plurality of dimension information includes:
quantifying the plurality of dimension information to obtain a quantified value corresponding to each dimension information;
determining quantified score values respectively corresponding to the plurality of evaluation factors based on the plurality of evaluation parameters and the plurality of quantified values; and
determining the grading parameters based on the quantified score values.

In some optional embodiments, after determining the quantified score values respectively corresponding to the plurality of evaluation factors based on the plurality of evaluation parameters and the plurality of quantified values, the method further includes:
determining differences between the evaluation parameters and the corresponding quantified score values;
determining at least one target evaluation factor from the plurality of evaluation factors based on the differences; and
outputting recommendation information corresponding to each of the at least one target evaluation factor.

In some optional embodiments, the plurality of business information is derived from a plurality of information collection devices, and the method further includes:
in a case that the grading parameter being lower than a preset grading parameter, determining that the difference between the quantified score value and the evaluation parameter is greater than a target preset dimension of a preset difference; and
controlling a target information collection device to output alarm information, wherein the target information collection device is configured to collect business information of the target preset dimension.

In some optional embodiments, the method further includes:
acquiring corresponding grading parameters of the physical area in a plurality of different time periods; and
outputting grading statistical information of the physical area based on the corresponding grading parameters in the plurality of different time periods to indicate grading changes of the physical area in different time periods in the target business.

In some optional embodiments, the acquiring a plurality of business information of a physical area on target business includes:
when a preset time period arrives, in response to a grading objective of the preset time period, acquiring business information of the physical area corresponding to the grading objective in the target business, wherein the grading objectives corresponding to the different preset time periods are the same or different; and
the plurality of preset dimensions correspond to the grading objectives.

In some optional embodiments, the acquiring a plurality of business information of an entity area in target business includes:
sending an information collection instruction to the plurality of information collection devices located in the physical area to indicate the information collection devices to collect facility states of facilities with which the information collection devices are configured; and
acquiring business information collected after the information collection performed by the plurality of information collection devices.

In a second aspect, the present disclosure provides an information processing system, including an Internet of Things platform and a plurality of information collection devices connected to the Internet of Things platform;
the plurality of information collection devices is configured to collect business information of a physical area on target business; and
the Internet of Things platform is configured to execute the information processing method described as the embodiments in the first aspect.

In a third aspect, the present disclosure provides an evaluation parameter output apparatus, including:
a factor acquisition module, configured to acquire a plurality of evaluation factors corresponding to the target business in the physical area from a database corresponding to the target business, one evaluation factor corresponding to one preset dimension of the target business;
a parameter determination module, configured to determine a plurality of evaluation parameters respectively corresponding to the plurality of evaluation factors; and
an output module, configured to send the plurality of evaluation parameters to an information processing platform, such that the information processing platform determines grading parameters of the physical area on the target business based on the plurality of evaluation parameters and a plurality of dimension information, wherein the grading parameters are configured to indicate a grade to which the physical area belongs, the information processing platform is an Internet of Things platform, or the information processing platform and the evaluation parameter output apparatus are integrated into the Internet of Things platform;
wherein, the dimension information is obtained by clustering a plurality of business according to the plurality of preset dimensions, and the plurality of business information includes at least state information of different facilities in the physical area.

In some optional embodiments, the parameter determination module includes:
a relationship construction unit, configured to construct an association relationship between the plurality of evaluation factors;
a weight acquisition unit, configured to output the association relationship and receive an initial weight inputted for each of the plurality of evaluation factors; and
a parameter determination unit, configured to determine the evaluation parameters respectively corresponding to the preset dimensions based on the initial weights.

In some optional embodiments, the apparatus further includes an influence parameter determination module and an adjustment module;
the influence parameter determination module is configured to receive an influence parameter inputted for evaluation factors that have an association relationship, and the influence parameter is configured to characterize an influence degree of occurrence of an event characterized by an evaluation factor on occurrence of an event characterized by another evaluation factor;
the adjustment module is configured to adjust initial weights of the evaluation factors based on the influence parameters; and
the parameter determination unit is configured to determine the evaluation parameters respectively corresponding to the preset dimensions based on the adjusted initial weights.

In some optional embodiments, the apparatus further includes an iteration adjustment module;
the iteration adjustment module is configured to adjust the initial weights of the plurality of evaluation factors in sequence, and when adjusting one evaluation factor each time, adjust an initial weight of an evaluation factor that has an association relationship with the one evaluation factor based on a random number corresponding to the one evaluation factor;
wherein, in response to adjusting an initial weight of an evaluation factor that has an association relationship with the one evaluation factor, the influence parameter determination module and the adjustment module are configured to adjust the initial weights of the evaluation factors; and
the parameter determination unit is configured to acquire the plurality of evaluation parameters respectively corresponding to the plurality of preset dimensions based on the adjusted initial weights respectively corresponding to the plurality of evaluation factors in the plurality of rounds of adjustments.

In some optional embodiments, the factor acquisition module is configured to acquire a plurality of evaluation factors from a database corresponding to the target business.

In some optional examples, the information processing platform is an Internet of Things platform, or the information processing platform and the output apparatus are integrated into the Internet of Things platform.

An embodiment of the present disclosure further provides an electronic device, including a memory, a processor and a computer program that is stored in the memory and operable on the processor, wherein the processor is configured to implement the information processing method described as the embodiments in the first aspect.

In a fourth aspect, the present disclosure further provides a computer-readable storage medium, wherein a computer program stored therein causes a processor to perform the information processing method described as the embodiments in the first aspect.

According to the information processing method provided by the embodiment of the present disclosure, a plurality of business information of a physical area on target business may be acquired; the plurality of business information may be clustered according to a plurality of preset dimensions to obtain dimension information respectively corresponding to the plurality of preset dimensions; next, evaluation parameters respectively corresponding to the plurality of preset dimensions are acquired; and then, grading parameters of the physical area on the target business are determined based on the plurality of evaluation parameters and the plurality of dimension information, among them, the plurality of business information includes at least information configured to describe states of different facilities in the physical area.

Since the acquired business information includes at least information configured to describe the states of the facilities in the physical area, the information on the states of the facilities may be configured to characterize whether the facilities are aging or faulty, so that the maintenance of the physical area may be reflected in a current time period. After the business information is clustered according to the preset dimensions, the business information reflecting the same dimension may be summarized and counted. Then, the grades of the physical area on the target business are evaluated according to the dimension information which is summarized and counted and the evaluation parameter corresponding to each preset dimension, so that the grade of the physical area may be determined based on the dimension information of the physical area and with reference to the evaluation parameters corresponding to the preset dimensions. Therefore, the automatic evaluation of the grade of the physical area on the target business is achieved, while the participation of manpower is reduced as much as possible, thereby providing a highly applicable landing plan for the automatic management and control of a building.

The above description is only an overview of the technical solution of the present disclosure. In order to have a clearer understanding of the technical means of the present disclosure, it can be implemented according to the content of the specification. In order to make the above and other purposes, features, and advantages of the present disclosure more obvious and easier to understand, the specific implementation methods of the present disclosure are listed below.

### BRIEF DESCRIPTION OF THE DRAWINGS

In order to provide a clearer explanation of the technical solutions in the embodiments of the present disclosure or in related art, a brief introduction will be given below to the accompanying drawings required in the descriptions of the embodiments or related art. It is obvious that the accompanying drawings in the following description are some embodiments of the present disclosure. For those skilled in the art, other accompanying drawings can be obtained based on these drawings without creative labor. It should be noted that the proportions in the accompanying drawings are only for illustrative purposes and do not represent the actual proportions.

FIG. 1 shows an implementation environment diagram of an information processing method according to an embodiment of the present disclosure;

FIG. 2 shows a flow chart of steps of an information processing method according to an embodiment of the present disclosure;

FIG. 3 shows a schematic diagram of an association relationship between constructed evaluation factors by taking Table 1 as an example;

FIG. 4a shows a schematic flow chart of a step of adjusting an initial weight;

FIG. 4b shows a schematic diagram of the setting of influence parameters of twenty-three evaluation factors by taking fire safety as an example;

FIG. 5 shows a schematic flow chart of a plurality of rounds of adjustments for an initial weight;

FIG. 6 shows a schematic flow chart of a step of solving evaluation parameters in the case of the plurality of rounds of adjustments;

FIG. 7 shows a schematic diagram of a frame structure of an evaluation parameter output apparatus; and

FIG. 8 shows a schematic diagram of a frame structure of an information processing system.

### DETAILED DESCRIPTION OF THE EMBODIMENTS

In order to clarify the purpose, technical solution, and advantages of the embodiments of the present disclosure, the following will provide a clear and complete description of the technical solution in the embodiments of the present disclosure in conjunction with the accompanying drawings. Obviously, the described embodiments are a part of the embodiments of the present disclosure, not all of them. Based on the embodiments of the present disclosure, all other embodiments obtained by persons skilled in the art without creative labor fall within the scope of protection of the present disclosure.

In related art, when performing comprehensive management and control on a physical area, it is generally necessary to evaluate a grade of the physical area on target business, so as to manage and control the physical area according to an evaluation result. However, the current evaluation strategy is generally based on manpower evaluation, and most of the management and control also relies on manpower management and control, which will consume more human resources, resulting in high manpower expenditure cost.

In view of this, the present disclosure proposes a solution that may automatically evaluate a grade of a physical area on target business, so as to perform automated integrated management and control of the physical area, and has a core concept of: acquiring a plurality of business information of the physical area on the target business; clustering the plurality of business information as a plurality of dimension information according to a plurality of preset dimensions; and then, evaluating the plurality of dimension information according to evaluation parameters respectively corresponding to the plurality of preset dimensions to obtain grading parameters of the physical area on the target business. This evaluation parameter may be configured to indicate an evaluation benchmark of the physical area under a preset dimension of the target business. This preset dimension may be set in advance, and the business information may be automatically collected, so when the physical area is evaluated based on the dimension information according to the evaluation parameter, a grade of the dimension information may be determined according to the benchmark indicated by the evaluation parameter. Next, the grades of the plurality of dimension information are integrated to determine the grading parameters of the physical area on the target business, thereby achieving the purposes of automatic evaluation and automatic management and control, thereby minimizing manpower participation in evaluation and management and control, and reducing the labor cost.

Application scenarios of the present disclosure may include: fire safety evaluation for a building, medical disinfection evaluation for hospitals and other medical places, and safety evaluation for a flow of people in a scenic area. Certainly, the above application scenarios do not represent the limitation on the present disclosure, and in practice, may also be applied to other scenarios.

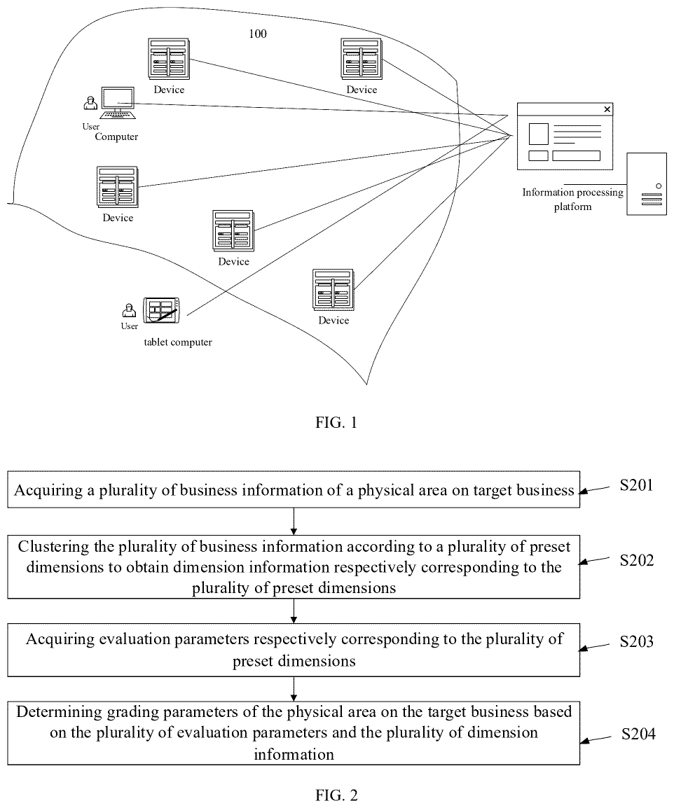

Referring to FIG. 1, an implementation environment diagram of an information processing method of the present disclosure is shown. FIG. 1 takes the fire safety evaluation for a building as an example, in which an information processing platform and a plurality of information collection devices arranged in a building 100 are included. As shown in FIG. 1, the plurality of information collection devices includes a device, a tablet computer and a computer. The information processing platform is in communication connection with the plurality of information collection devices, and the communication connection may be transmission control protocol (TCP), hyper text transfer protocol (HTTP), message queuing telemetry transport (MQTT) and other connections. This information collection device is configured to collect state information of different facilities of the building, wherein the information processing platform may be an Internet of Things platform, and the information processing platform may be located in the cloud or in a server in a local area network.

The plurality of information collection devices may be different depending on different types of information to be collected. Specifically, each business information may correspond to one information collection device, and the information collection device may be a sensor, a computer, a camera, a tablet computer, a mobile phone, etc.

The plurality of information collection devices may be located partially or wholly in the physical area, or partially in the physical area, and partially located outside the physical area as mobile information collection devices. For example, when the information collection devices are a sensor and a camera, they are located in the physical area to collect state information of facilities in the physical area. For example, when the information collection device is a tablet computer, a computer or a mobile phone, it may be located outside the physical area to collect information on a development state of measures for carrying out the target business.

Taking fire safety evaluation as an example, business information to be collected includes a fire hydrant system, and then the information collection device may include a camera which is configured to collect an image of a fire hydrant and process the image of the fire hydrant, so as to obtain a state of the fire hydrant. If the business information to be collected is a fire water supply facility, the integrity of the fire water supply facility needs to be detected, and the information collection device may be a water pressure sensor which is configured to collect a water pressure state of the fire water supply facility.

Certainly, in some other embodiments, the information collection device may be integrated into a fire-fighting facility, e.g., integrated into a smoke alarm, which may be detected in real time to determine whether the smoke alarm is faulty, and send the business information according to a detection result.

Also taking medical safety evaluation as an example, when the business information to be collected includes a ventilation system, the information collection device may include an air flow sensor, which is configured to collect an air flow at all parts of the ventilation system. When the business information to be collected is a working state of each disinfection device in a disinfection room, the information collection device may be a sensor integrated into each disinfection device to collect state information of the disinfection device.

An information processing method of the present disclosure is described in conjunction with the implementation environment shown in FIG. 1. Referring to FIG. 2, a flow chart of steps of an information processing method is shown. As shown in FIG. 2, this method may be applied to an information processing platform, and the information processing platform may be located in the cloud or in a server. The method may specifically include the following steps S201 to S205.
Step S201: acquiring a plurality of business information of a physical area on target business.

The plurality of business information includes at least information configured to describe states of different facilities in the physical area.

The physical area in the present disclosure may refer to a building area e.g., a shopping mall or a mansion, or to a geographical area including open areas and buildings, e.g., a scenic area. The target business may be understood as business in the physical area that needs to be evaluated. When the physical area needs to be evaluated for fire safety, the target business may refer to fire safety evaluation business; when the physical area needs to be evaluated for health defense, the target business may refer to medical safety evaluation business; and when the physical area is a scenic area, and a level of pedestrian safety protection in the case of a large people flow needs to be evaluated, and the target business may refer to pedestrian safety protection business.

One physical area may correspond to a plurality of target business, which means that the physical area may be evaluated on the plurality of target business.

The plurality of business information may include information configured to describe states of different facilities in the physical area. The state of the facility may refer to a working state of the facility. This business information may reflect whether the facilities in the physical area are faulty and reflect the levels of performances. In some examples, the plurality of business information may also include information on some management measures taken by the physical area to meet evaluation standards for the target business. This business information may be inputted by a user in an electronic device, e.g., in a mobile phone, a tablet computer or a computer. For example, taking fire safety evaluation, i.e., fire drills for fire safety, as an example, corresponding business information may be acquired through the entry by a user into an electronic device.

It may be understood that a plurality of business information may include a plurality of business information of the same type. For example, for ventilation facilities in a hospital, air flow sensors are generally arranged in a plurality of positions to generate a plurality of air flow information, and different air flow information reflect ventilation situations at different positions.
Step S202: clustering the plurality of business information according to a plurality of preset dimensions to obtain dimension information respectively corresponding to the plurality of preset dimensions.

In the present disclosure, the plurality of preset dimensions may refer to dimensions that influence the evaluation of the physical area on the target business. Exemplarily, taking fire safety evaluation as an example, the dimensions that influence the fire safety evaluation for a building may be twenty-three dimensions. As shown in Table 1 shown in the subsequent embodiment, a plurality of business information may be clustered according to the plurality of preset dimensions; and during clustering, the business information that reflects the same preset dimension is taken as a cluster, so that a plurality of dimension information is obtained.

The plurality of preset dimensions may be stored in the information processing platform in advance and correspond to the target business. That is, each target business corresponds to each of the plurality of preset dimensions.

Among the plurality of dimension information obtained by clustering, each dimension information may include at least one business information. In a case that the dimension information includes a plurality of business information, the plurality of business information may be the same type of information, e.g., business information on a ventilation state in the above example. Certainly, the plurality of business information may also be different types of information. For example, in the fire safety evaluation business, the preset dimension is safety evacuation of a building, and then, the plurality of business information may include stairs, passages, walkways and other information.
Step S203: acquiring evaluation parameters respectively corresponding to the plurality of preset dimensions.

The evaluation parameters respectively corresponding to the plurality of preset dimensions may be acquired from a database. This evaluation parameter may be understood as a score value corresponding to a highest evaluation grade of the physical area on the preset dimension. Taking the fire safety evaluation business as an example, in a case that the preset dimension is safety evacuation of a building and the evaluation parameter is 3, a score of 3 is considered to be the highest evaluation grade. Therefore, the evaluation parameter may be regarded as a benchmark evaluation score of the preset dimension, which may be used to evaluate the physical area on the target business subsequently in conjunction with the dimension information of the physical area.
Step S204: determining grading parameters of the physical area on the target business based on the plurality of evaluation parameters and the plurality of dimension information.

The grading parameter is configured to indicate a grade to which the physical area belongs.

Since the business information is actual information of the physical area on the target business, it reflects actual situations of the facilities in the physical area and measures for implementing the target business, while the evaluation parameter is a benchmark evaluation score corresponding to a highest evaluation grade of the physical area on the preset dimension. For each preset dimension, the score of the physical area on the preset dimension may be determined based on the evaluation parameter corresponding to this preset dimension and the dimension information of this preset dimension. Next, a comprehensive score of the physical area is obtained based on the scores of the physical area on a plurality of preset dimensions, such that a grading parameter of the physical area on the target business may be determined according to the comprehensive score.

This grading parameter may be a grade parameter, e.g., a high, medium or low grade, or may be a value of the comprehensive score. In a case that a full score system is a 100-point system, the comprehensive score may be 80, 90 and other points, and then the grading parameter may be a score under the 100-point system.

After the grading parameter is obtained, this grading parameter of the physical area may be displayed, or this grading parameter may also be fed back to a terminal of a superior department of the physical area and a client corresponding to the physical area, so that the facilities of the physical area may be maintained and rectified according to the score of each preset dimension.

By adopting the embodiments of the present disclosure, the acquired business information may be configured to characterize whether the facilities are aging or faulty, etc., and may be automatically collected by the information collection devices. After a plurality of business information is obtained, the business information may be clustered according to the preset dimensions, and the grading parameter is automatically determined for the grade of the physical area on the target business according to the clustered dimension information and the evaluation parameter corresponding to each preset dimension. Therefore, a high degree of automation from information collection to determination of the grading parameter is achieved, and the manpower participation is reduced, thereby providing a highly applicable landing plan for the automatic control of a building.

In some embodiments, the plurality of business information of the physical area in the target business may be acquired in different time periods to meet the needs of the physical area in different time periods, and grading objectives of the target business may have different demands. The grading objective of the target business may refer to a degree of grade evaluation for the target business. For example, in a case that the physical area is a scenic area, it may be divided into off-season and peak season, wherein evaluation objectives of pedestrian safety protection in off-season and peak season may be different. Therefore, the divisions of preset dimensions may also be different. In this way, in different time periods, the types of preset dimensions may be different depending on different grading objectives, and the types of the acquired business information may be different.

During specific implementation, as a preset time period arrives, in response to the grading objective of the preset time period, business information of the physical area corresponding to the grading objective in the target business may be acquired. The grading objectives corresponding to the different preset time periods may be the same or different, and the plurality of preset dimensions corresponds to the grading objectives.

Specifically, in the case of different time periods and different grading objectives, the acquired business information may also be different in terms of types and quantity. Specifically, in the case of different grading objectives, the preset dimensions divided by the same target business may also be different in terms of types and quantity, while in the case of different preset dimensions, the business information to be acquired will be different accordingly.

Exemplarily, taking the physical area being a scenic area as an example, the physical area may be divided into off-season and peak season. If the pedestrian safety protection is evaluated in the off-season, the grading objective may be directed for the more basic safety protection evaluation, e.g., whether a safety fence is in good condition, whether cable car components and parts are normal, or whether a mountain body has a landslide risk, and the collected business information may be directed for image collection for the safety fence, the cable car components and parts and roads. If the pedestrian safety protection is evaluated in the peak season, the grading objective may be a higher protection requirement, in addition to protection requirements in the off-season, it is also necessary to add: whether safety rescue facilities (rescue vehicles) are sufficient, whether people flow counting facilities are intact, etc.; and secondly, if a summer flood period is encountered, it is also necessary to add: information collection for flood monitoring devices, e.g., in rivers and valleys to monitor whether these flood monitoring devices are in normal working conditions.

In the present disclosure, the preset time period may be stored in the information processing platform and may be preset in a timer. As the preset time period arrives, the information processing platform may send an information collection instruction to the corresponding information collection device according to the grading objective corresponding to the preset time period to collect the corresponding business information, so as to determine subsequent grading parameters according to the plurality of preset dimensions corresponding to the preset time periods.

By adopting this embodiment, the information processing platform may automatically match different grading objective requirements along with different time periods, determine the grading parameters for the physical area that match the current time period, and achieve a logic of information processing and self-adaption of time periods, so that the automation level of automatic management and control of the physical area may be further improved.

When acquiring the business information, as mentioned above, since the information processing platform may be connected to a plurality of information collection devices, the business information may be acquired by sending an instruction to the information collection devices. During specific implementation, as the preset time period arrives, an information collection instruction may be sent to the plurality of information collection devices located in the physical area to indicate the information collection devices to collect facility states of configured facilities. Next, the business information collected after the information collection performed by the plurality of information collection devices is acquired.

As mentioned above, as the preset time period arrives, the information processing platform may determine the business information that needs to be collected according to the grading objective corresponding to the preset time period, and then send the information collection instruction to the information collection device that needs to collect business information, and the information collection device begins to collect the corresponding business information after receiving the information collection instruction.

In a case that the information collection device performs collection for a facility in the physical area, the information collection instruction may be sent to the information collection device through a communication link between the information processing platform and the information collection device, the information collection instruction may awaken and activate the information collection device, and the information collection device may begin to collect a state of the facility after being awakened and activated. In this way, the information collection device may sleep in a time period during which business information collection is not required, in order to save energy consumption. However, in a case that business information collection is required, the business information collection begins in response to the information collection instruction being awakened.

In a case that the information collection device performs collection for a protection measure taken for the target business in the physical area, the information collection instruction may be sent to the information collection device through a communication link between the information processing platform and the information collection device; and the information collection device may display information indicated by the information collection instruction to instruct a user to enter relevant business information, and after the entry of a user entry, report information entered by the user to the information processing platform as the business information.

In this embodiment, regardless of the business information corresponding to the facility or the business information corresponding to the measure, the business information may be collected automatically, thereby reducing the manpower participation in information collection and saving the labor cost.

The following describes how to acquire evaluation parameters respectively corresponding to the plurality of preset dimensions. In order to acquire more accurate evaluation parameters, evaluation factors associated with the plurality of preset dimensions may be acquired first. The evaluation factors may be understood as information with the same meaning as the preset dimensions. For example, taking the fire safety evaluation as an example, the preset dimension is a dimension of a building fire zone, and the evaluation factor is the building fire zone. Generally speaking, the grading evaluation of the physical area on the target business may be determined by dimension information in the plurality of preset dimensions, while the dimension information of one preset dimension is not isolated for evaluation, but has a mutual influence with the dimension information of other preset dimensions. That is, the dimension information of the plurality of preset dimensions interacts with each other, and a grade evaluation result may be understood as an interaction result.

In practice, in some embodiments, in order to accurately determine the evaluation parameters of the evaluation factors, an association relationship between a plurality of evaluation factors may be constructed to depict the mutual influence of the plurality of evaluation factors on the grade evaluation, that is, to depict an influence degree of the occurrence of an event represented by one evaluation factor on the occurrence of an event represented by another evaluation factor, so that the evaluation parameter of each evaluation factor may be accurately obtained according to the association relationship.

During specific implementation, the evaluation factors respectively corresponding to the plurality of preset dimensions may be acquired first, and the association relationship between the plurality of evaluation factors may be constructed; an initial weight of each evaluation factor may be determined based on the association relationship; and the evaluation parameters respectively corresponding to the preset dimensions may be determined based on the initial weights.

In this embodiment, the evaluation factors corresponding to the plurality of preset dimensions may be acquired from a database, wherein one preset dimension corresponds to one evaluation factor, or one preset dimension corresponds to the plurality of evaluation factors. Since the plurality of evaluation factors are factors related to the evaluation of the grading parameters of the physical area on the target business, one evaluation factor may characterize one influence factor of the physical area on the target business, indicating that an event represented by the evaluation factor has an influence on the evaluation of the physical area on the target business. Taking fire safety evaluation as an example, the evaluation factor is a fire water supply facility, and characterizes the influence of the fire water supply facility in the physical area on fire safety.

Taking fire safety evaluation as an example, according to the influences of the evaluation factors on the target business, the evaluation factors may be divided into direct factors, indirect factors and deep factors. The direct factors may be the direct factors that lead to the occurrence of a fire accident, such as: fire zone, facility integrity, and fire hazards. The indirect factors refer to the reduction of a potential possibility of fire from the source, such as: whether the secondary decoration meets the standards, the implementation of a fire safety responsibility system, a fire safety system and operating procedures, fire drills, and miniature fire station management. The deep factors lie in the reduction of the source of fire through fire drills, such as: the building legality, whether a fire extinguishing and emergency evacuation plan is prepared, and whether employees regularly conduct fire protection knowledge training.

As mentioned above, for the target business, a single evaluation factor has an influence on the evaluation of the physical area on the target business, and this influence is in turn influenced by other evaluation factors. For example, the indirect factors and deep factors mentioned above may act together with the direct factors to influence the fire safety of the physical area. Therefore, a mutual influence relationship exists between the plurality of evaluation factors. In the present disclosure, the mutual influence between the plurality of evaluation factors may be depicted by constructing the association relationship between the plurality of evaluation factors.

The association relationship between the evaluation factors may be constructed between the evaluation factors that are influenced mutually. For example, in a case that an evaluation factor A and an evaluation factor B are influenced mutually, an association relationship between the evaluation factor A and the evaluation factor B may be constructed. It may be understood that this association relationship may include a direct association relationship and an indirect association relationship.

The direct association relationship refers to a direct influence between the two evaluation factors. Exemplarily, taking fire safety evaluation as an example, in a case that a building fire zone meeting the fire protection standards is an evaluation factor A and daily fire protection and fire safety inspection is an evaluation factor B, the evaluation factor A is directly influenced by the evaluation factor B, so the two evaluation factors have a direct association relationship.

The indirect association relationship refers to an indirect influence between the two evaluation factors through another evaluation factor. Exemplarily, taking fire safety evaluation as an example, in a case that a building fire zone meeting the fire protection standards is an evaluation factor A and daily fire protection and fire safety inspection is an evaluation factor B, the evaluation factor A is directly influenced by the evaluation factor B. In a case that the functional nature of the building floors being in line with an original design is an evaluation factor C, the evaluation factor C is directly influenced by the evaluation factor B, and then the evaluation factor A and the evaluation factor C belong to an indirect influence relationship, that is, an indirect association relationship.

After the association relationship between the evaluation factors is acquired, an internal logical topology diagram between a plurality of evaluation factors may be constructed. The intrinsic logic topology diagram may reflect an influence relationship and influence degree between the plurality of evaluation factors. Therefore, an initial weight of each evaluation factor may be set based on this association relationship. Generally speaking, for an evaluation factor, the greater the quantity of evaluation factors that have an association relationship, the larger its initial weight may be, and the more important the grade evaluation is characterized.

The evaluation parameter may be understood as a weight value obtained after the initial weight is adjusted. The initial weight of one evaluation factor may be understood as an influence degree of this evaluation factor on the grade evaluation of the physical area, or as the importance of this evaluation factor to the grade evaluation. For example, in the fire safety evaluation, the initial weight of one evaluation factor may be understood as an importance degree of a fire hazard posed to fire safety.

Exemplarily, taking two evaluation factors that a building fire zone meets fire protection standards and secondary decoration inside the building meet fire protection standards as examples, the initial weight of the former is 0.05 and the initial weight of the latter is 0.03, indicating that the importance of the former to fire safety is higher than that of the latter to fire safety.

It may be understood that the larger the initial weight is, the higher the importance degree is, and conversely, the smaller the initial weight is, the lower the importance degree is.

After the association relationship is constructed, an internal logical association between the evaluation factors may be depicted, so as to achieve a hierarchical division for the influences of the evaluation factors on the target business. More other platform factors associated with an evaluation factor characterize more evaluation factors that have direct and indirect influences with this evaluation factor, and the more other evaluation factors that have direct and indirect influences with this evaluation factor characterize that this evaluation factor is a factor that has an important influence on the evaluation for the target business. After these evaluation factors are characterized by the association relationship, a more accurate mutual influence relationship between the evaluation factors may be obtained, so that more accurate evaluation parameters may be obtained according to the more accurate mutual influence relationship.

In some examples, an influence relationship inputted for the plurality of evaluation factors may be received as the association relationship between the evaluation factors is constructed, the influence relationship is configured to characterize a direct association between the evaluation factors; and the association relationship is constructed based on the influence relationship.

In this example, this influence relationship may be inputted by the user for the plurality of evaluation factors and characterize the direct influence between the evaluation factors. For example, if there are evaluation factors C and D that directly influence the evaluation factor A, the evaluation factors C and A have a direct influence relationship, and the evaluation factors A and D also have a direct influence relationship.

Taking fire safety evaluation as an example, the obtained evaluation factors are shown in Table 1 below. The influence relationship between the evaluation factors is also shown in Table 1 below. Table 1 shows the evaluation factors and other evaluation factors that have an influence relationship with the evaluation factors.

TABLE 1
Schematic table of evaluation factors and influence relationships

| Serial | | |
|---|---|---|
| No. | Factor | Direct evaluation factor |
| D1 | The building fire zone is | D15, D16, D20 |
| | maintained in line with the | |
| | fire protection standards | |
| D2 | The second decoration inside | D15, D16, D23 |
| | the building is in line with | |
| | the fire protection | |
| | standards | |
| D3 | The functional nature of the | D15, D16, D23 |
| | building floors is in line | |
| | with an original design | |
| D4 | Building safety evacuation | D15, D16, D20, D21 |
| | passages, stairs, exits and | |
| | refuge floors (walkways) are | |
| | kept in line with the fire | |
| | protection standards | |
| D5 | Fire water supply facility | D6, D7, D16, D18 |
| D6 | Fire hydrant system | D7, D16, D18 |
| D7 | Automatic sprinkler system | D6, D16, D18 |
| D8 | Automatic fire alarm system | D16, D18, D20 |
| D9 | Electrical fire monitoring | D8, D16, D18, D20, D23 |
| | system | |
| D10 | Combustible gas detection | D8, D16, D18 |
| | system | |
| D11 | Building legality | D1, D3, D4 |
| D12 | Implementation of the fire | D17, D18 |
| | safety responsibility system | |
| D13 | Formulation of fire safety | D17, D18 |
| | system | |
| | and operating procedures | |
| D14 | Fire management organization | D17, D18 |
| D15 | Daily fire patrol and fire | D1, D3, D4, D16, D18, D22, |
| | safety inspection | D23 |
| D16 | Fire hazard rectification | D15, D17, D23 |
| D17 | Fire control room management | D5, D6, D7, D8, D9, D10, D23 |
| D18 | Maintenance of fire-fighting | D5, D6, D7, D8, D9, D10, D23 |
| | facilities | |
| D19 | Employee fire safety education | D1, D2, D4 |
| | and training | |
| D20 | Fire extinguishing and | D21 |
| | emergency evacuation | |
| | plan | |
| D21 | Fire drills | D14 |
| D22 | Miniature fire station | D20 |
| | management | |
| D23 | Fire occurrence | |

Since the direct influence relationship is the most direct association relationship between the evaluation factors, there is also an indirect influence relationship under the direct influence relationship between the plurality of evaluation factors. Therefore, a relationship including indirect association and direct association needs to be constructed based on the direct influence relationship between the evaluation factors.

The construction of the association relationship including direct association and indirect association based on the direct influence relationship may be implemented based on an association matrix.

During specific implementation, an association matrix A (adjacency matrix) between the evaluation factors may be further obtained according to the above influence relationship table between the evaluation factors (as shown in Table 1). The association matrix is subjected to a power operation according to the Boolean algebra. A reachable matrix M is obtained after several iterations. Next, an analytical hierarchy process of hazard factors is performed based on the reachable matrix, and a reachable set and a leading set (antecedent set) are used to determine a grade to which the hazard factors belong, thereby constructing an association relationship of all factors.

The association matrix A may be constructed with reference to the above formula (1):

$$formula ( 1 )$$

$$A = {( {D}_{ij} )}_{23 \times 23} \{ \begin{matrix}{D}_{ij} = 1 , indicating a direct influence of {D}_{i} on {D}_{j} \\ {D}_{ij} = 0 , indicating no direct influence of {D}_{i} on {D}_{j}\end{matrix} ;$$

the reachable matrix M may be obtained by the following formula (2):

$$M = {( A + I )}^{n + 1} = {( A + I )}^{n} \neq {( A + I )}^{n - 1} ( I is a unit matrix ) ; \qquad formula ( 2 )$$

the constructed reachable set is P(Sᵢ)={Sⱼ|mᵢⱼ=1} i=1,2,3 . . . n.
the constructed leading set is Q(Sᵢ)={Sⱼ|mⱼᵢ=1} i=1,2,3 . . . n.
wherein, if P(Sᵢ)∩P(Sᵢ)=P(Sᵢ), Si is a current top-grade element;
in the above formula, Dᵢ represents an evaluation factor i; Dⱼ represents an evaluation factor j; mᵢⱼ=1 represents that the occurrence of an event corresponding to the evaluation factor i has an influence on the occurrence of an event corresponding to the evaluation factor j, that is, the evaluation factor i is an antecedence of the evaluation factor j; mⱼᵢ=1 represents that the occurrence of the event corresponding to the evaluation factor j has an influence on the occurrence of the event corresponding to the evaluation factor i, that is, the evaluation factor j is an antecedence of the evaluation factor i.

Exemplarily, taking seven evaluation factors as an example, a calculation process is as follows.

It is assumed that an association relationship between the seven evaluation factors is shown in Table 2 below:

TABLE 2
Association relationship table between the seven evaluation factors

| | Factor 1 | Factor 2 | Factor 3 | Factor 4 | Factor 5 | Factor 6 | Factor 7 |
|---|---|---|---|---|---|---|---|
| Factor 1 | 0 | 0 | 1 | 1 | 1 | 0 | 0 |
| Factor 2 | 0 | 0 | 0 | 0 | 0 | 1 | 1 |
| Factor 3 | 0 | 1 | 0 | 0 | 0 | 0 | 0 |
| Factor 4 | 0 | 1 | 0 | 0 | 0 | 0 | 0 |
| Factor 5 | 0 | 0 | 0 | 0 | 0 | 1 | 0 |
| Factor 6 | 0 | 0 | 0 | 0 | 0 | 0 | 1 |
| Factor 7 | 0 | 0 | 0 | 0 | 0 | 0 | 0 |

Then, an adjacency matrix (association matrix) is as follows and denoted A:

$$A = [ \begin{matrix}0 & 0 & 1 & 1 & 1 & 0 & 0 \\ 0 & 0 & 0 & 0 & 0 & 1 & 1 \\ 0 & 1 & 0 & 0 & 0 & 0 & 0 \\ 0 & 1 & 0 & 0 & 0 & 0 & 0 \\ 0 & 0 & 0 & 0 & 0 & 1 & 0 \\ 0 & 0 & 0 & 0 & 0 & 0 & 1 \\ 0 & 0 & 0 & 0 & 0 & 0 & 0\end{matrix} ]$$

The unit matrix I is set to be:

$$I = [ \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1\end{matrix} ]$$

The adjacency matrix A and the unit matrix I are summed:

$$A + I = [ \begin{matrix}1 & 0 & 1 & 1 & 1 & 0 & 0 \\ 0 & 1 & 0 & 0 & 0 & 1 & 1 \\ 0 & 1 & 1 & 0 & 0 & 0 & 0 \\ 0 & 1 & 0 & 1 & 0 & 0 & 0 \\ 0 & 0 & 0 & 0 & 1 & 1 & 0 \\ 0 & 0 & 0 & 0 & 0 & 1 & 1 \\ 0 & 0 & 0 & 0 & 0 & 0 & 1\end{matrix} ] .$$

The reachable matrix is calculated as continuous self-multiplication of (A+I) (i.e., a matrix multiplication operation) until it no longer changes:

$$M = {( A + I )}^{n + 1} = {( A + I )}^{n} \neq {( A + I )}^{n - 1} .$$

The calculated reachable matrix M is shown in Table 3 below:

TABLE 3
Reachable matrix M table

| | Factor 1 | Factor 2 | Factor 3 | Factor 4 | Factor 5 | Factor 6 | Factor 7 |
|---|---|---|---|---|---|---|---|
| Factor 1 | 1 | 1 | 1 | 1 | 1 | 1 | 1 |
| Factor 2 | 0 | 1 | 0 | 0 | 0 | 1 | 1 |
| Factor 3 | 0 | 1 | 1 | 0 | 0 | 1 | 1 |
| Factor 4 | 0 | 1 | 0 | 1 | 0 | 1 | 1 |
| Factor 5 | 0 | 0 | 0 | 0 | 1 | 1 | 1 |
| Factor 6 | 0 | 0 | 0 | 0 | 0 | 1 | 1 |
| Factor 7 | 0 | 0 | 0 | 0 | 0 | 0 | 1 |

According to the reachable matrix, the reachable set and the leading set (antecedent set) are sorted as shown in Table 4 below:

TABLE 4
Reachable set and leading set table

| | Reachable set R | Leading set Q | Intersection═R∩Q |
|---|---|---|---|
| Factor 1 | 1,2,3,4,5,6,7 | 1 | 1 |
| Factor 2 | 2,6,7 | 1,2,3,4 | 2 |
| Factor 3 | 2,3,6,7 | 1,3 | 3 |
| Factor 4 | 2,4,6,7 | 1,4 | 4 |
| Factor 5 | 5,6,7 | 1,5 | 5 |
| Factor 6 | 6,7 | 1,2,3,4,5,6 | 6 |
| Factor 7 | 7 | 1,2,3,4,5,6,7 | 7 |

In this way, according to the above process, the association relationship between the respective evaluation factors may be obtained according to the influence relationship (direct association relationship) between the evaluation factors.

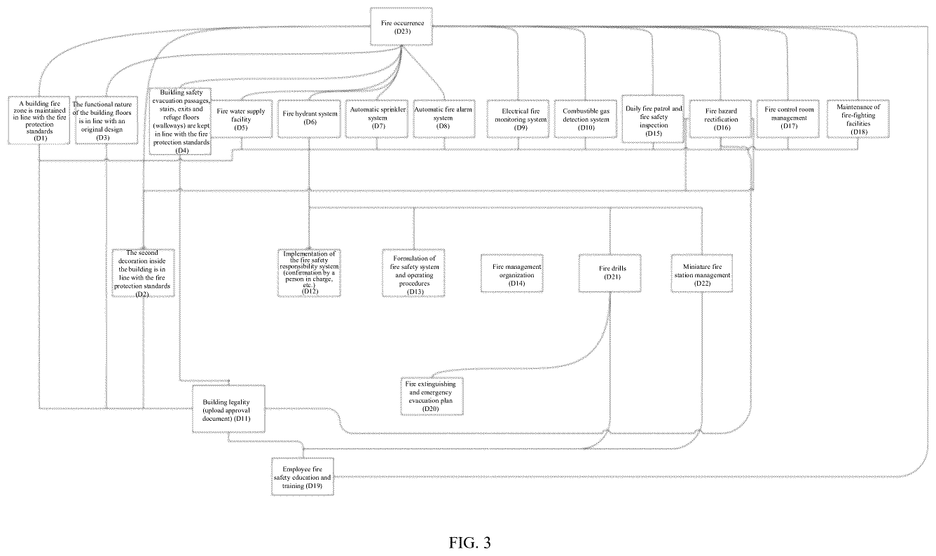

Exemplarily, referring to FIG. 3, taking Table 1 as an example, FIG. 3 shows a schematic diagram of an association relationship between the constructed evaluation factors. From FIG. 3, an internal logical relationship between the evaluation factors may be seen intuitively.

In some examples, after the association relationship is obtained, an initial weight may be set for each evaluation factor based on this association relationship. This initial weight may be understood as a probability of the occurrence of the target business caused by the evaluation factor, which is called an occurrence probability. For example, taking fire safety evaluation as an example, the evaluation factor is a fire water supply facility. Assuming that the initial weight of this evaluation factor is set to 0.1, it is indicated that there will be a 10% probability of causing a fire if the fire water supply facility is faulty.

A way of setting the initial weights is to display the association relationship, and then receive the initial weight inputted by the user for each evaluation factor for the association relationship; and another way of setting the initial weights is to set, for an evaluation factor, according to a quantity of other evaluation factors that have an association relationship with this evaluation factor, an initial weight corresponding to this quantity. For example, as shown in FIG. 3, the quantity of evaluation factors that have an association relationship with the occurrence of a fire may be set to 0.10 at most.

In a case that, according to the quantity of evaluation factors that have an association relationship, the initial weight corresponding to this quantity is set, a target evaluation factor that has an association relationship with the largest quantity of the evaluation factors may be determined first, that is, the quantity of the evaluation factors influenced by the target evaluation factor is the largest. According to the quantity of the evaluation factors influenced by this target evaluation factor, the initial weight of the target evaluation factor is set. Next, according to the initial weight of the target evaluation factor, the initial weights of other evaluation factors are determined. Certainly, it may be understood that the smaller the quantity of the evaluation factors that have an association relationship, the smaller the initial weight, wherein the initial weights of other evaluation factors other than the target evaluation factor may be smaller than that of the target evaluation factor.

In this way of setting the initial weight according to the quantity, the initial weight of each evaluation factor may be automatically set by an information processing platform according to the association relationship, without manual setting, which further avoids the manpower participation, thereby improving the degree of automatic control.

Next, the evaluation parameter of each evaluation factor needs to be obtained based on the initial weight of each evaluation factor.

In one case, the evaluation parameter may be the initial weight, and in another case, the evaluation parameter may be a weight obtained by further adjustment of the initial weight.

The initial weight may be a value between 0 and 1, and the evaluation parameter may be a 100-point system numerical value of the initial weight, i.e., the evaluation parameter is 5 if the initial weight is 0.05. Certainly, the initial weight may also be a 100-point system numerical value, e.g., 5, and the evaluation parameter may also be a 100-point system numerical value, which will not be specially limited here.

Among the ways of adjusting the initial weights to determine the evaluation parameters respectively corresponding to the preset dimensions, one way may be to set corresponding influence parameters respectively corresponding to the evaluation factors, and then adjust the initial weights based on the influence parameters, the influence parameters are configured to characterize influence magnitudes of an evaluation factor on evaluation factors that have an association relationship with this evaluation factor; and another way may be to adjust the initial weight of the evaluation factor in a plurality of rounds of adjustments according to a random number that is generated randomly. In the plurality of rounds of adjustments, the initial weights may be adjusted based on the influence parameters. In this way, in each round of adjustments, an adjusted initial weight may be obtained from a plurality of evaluation factors. Therefore, after the plurality of rounds of adjustments, each evaluation factor has a plurality of adjusted initial weights, and a final evaluation parameter of an evaluation factor may be obtained according to the plurality of adjusted initial weights.

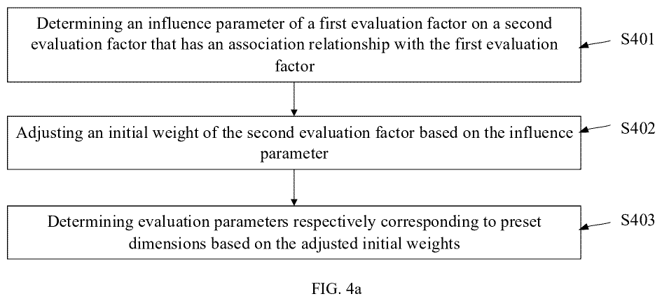

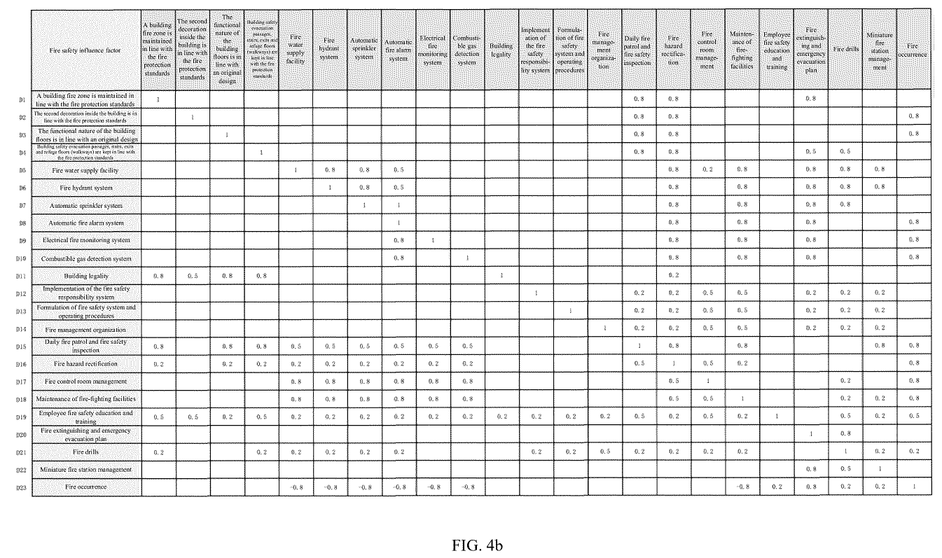

During specific implementation, in one way, referring to FIG. 4a, a schematic flowchart of a step of adjusting an initial weight is shown. As shown in FIG. 4a, the following specific steps S401 to S403 may be included specifically.
Step S401: determining an influence parameter of a first evaluation factor on a second evaluation factor that has an association relationship with the first evaluation factor.

The influence parameter is configured to characterize an influence degree of the first evaluation factor on the second evaluation factor, and the first evaluation factor is any evaluation factor among the plurality of evaluation factors.

In the present disclosure, the influence degree of the first evaluation factor on the second evaluation factor that has an association relationship with the first evaluation factor includes an influence magnitude and an influence direction, wherein the influence direction indicates whether it is a positive or negative influence.

As shown in Table 5, a schematic diagram of the setting of influence parameters is shown. K represents the influence direction, wherein a positive value represents a positive influence, indicating, in response to the occurrence of an event characterized by an evaluation factor, an increase in the probability of occurrence of an event characterized by another evaluation factor that has an association relationship with this evaluation factor; and a negative value represents a negative influence, indicating, in response to the occurrence of an event characterized by an evaluation factor, a decrease in the probability of occurrence of an event characterized by another evaluation factor that has an association relationship with this evaluation factor. S indicates a magnitude of an influence parameter, and the higher its value, the greater the influence degree.

TABLE 5
Influence parameter setting table

| Cross-influence direction and | | |
|---|---|---|
| degree | K | S |
| No influence | 0 | 0 |
| Less positive influence | +1 | 0.2 |
| Less negative influence | −1 | 0.2 |
| Strong positive influence | +1 | 0.5 |
| Strong negative influence | −1 | 0.5 |
| Very strong positive influence | +1 | 0.8 |
| Very strong negative influence | −1 | 0.8 |

The influence parameter of the evaluation factor may be determined according to the influence magnitudes of this evaluation factor on other evaluation factors. For an evaluation factor, influence parameters of the evaluation factor on different evaluation factors may be different when this evaluation factor has an association relationship with the different evaluation factors. For example, for an evaluation factor A which has an association relationship with both evaluation factors B and C, an influence parameter of the evaluation factor A on the evaluation factor B may be different from an influence parameter of the evaluation factor A on the evaluation factor C.

That is, the first evaluation factor may have different influence parameters on different second evaluation factors. Referring to FIG. 4b, taking fire safety as an example, a schematic diagram of the setting of influence parameters of twenty-three evaluation factors is shown. As shown in FIG. 4b, the influence parameter may be expressed in the same way as the initial weight, e.g., a numerical value between 0 and 1. The influence parameter may be set as shown in Table 5 in the setting process. That is, according to other evaluation factors influenced by an evaluation factor, the influence parameters of this evaluation factor on the other evaluation factors may be set according to several preset influence parameters. As shown in FIG. 4b, the influence parameter may be set to 1, 0.8, 0.2, or 0.5.

It may be understood that the influence parameters may be 0 and 1.
Step S402: adjusting an initial weight of the second evaluation factor based on the influence parameter.
Step S403: determining evaluation parameters respectively corresponding to preset dimensions based on the adjusted initial weights.

When adjusting the initial weight of the second evaluation factor, because the second evaluation factor is influenced by the first evaluation factor, the initial weight of the second evaluation factor may be finely tuned according to the influence parameter. For each evaluation factor, the initial weight of each other evaluation factor that has an association relationship with this evaluation factor may be adjusted.

In one example, the initial weight may be adjusted according to a cross-influence empirical formula (3):

$${P}_{j}^{′} = {P}_{j} + {KS}_{ij} ( {P}_{j} - 1 ) {P}_{j} , ( 1 , 2 , 3 … n ) \qquad formula ( 3 )$$

In the formula (3), Pⱼ is a probability value of the occurrence of an evaluation factor Dᵢ before the occurrence of the evaluation factor Dⱼ; P′ⱼ is a probability value of the occurrence of the evaluation factor Dⱼ after the occurrence of an event Dⱼ; KSᵢⱼ is an influence parameter of the evaluation factor Dᵢ on the evaluation factor Dⱼ; K is an influence direction; Sᵢⱼ is an influence degree; and a value of Sᵢⱼ is a value given by the above Table 5.

The probability value of the occurrence of the evaluation factor Dⱼ is an initial weight of Dⱼ; and the probability value of the occurrence of the evaluation factor Dⱼ is an initial weight of Dⱼ.

In practice, one evaluation factor may be adjusted by influence parameters of a plurality of evaluation factors. In this case, the initial weights of one evaluation factor respectively adjusted by influence parameters of a plurality of evaluation factors may be calculated. In this way, one evaluation factor may obtain a plurality of adjusted initial weights, and in practice, an average of the plurality of adjusted initial weights may be used as a final adjusted weight of this evaluation factor.

Exemplarily, as shown in FIG. 4b, an evaluation factor “daily fire patrol” may be influenced by evaluation factors D1-D4. Therefore, four weights adjusted by the influence parameters of the evaluation factors D1-D4 may be obtained accordingly, and an average of the four weights may be used as a final adjusted initial weight of this evaluation factor “daily fire patrol”.

By means of such adjusting way, the initial weight may be adjusted quickly, with high calculation efficiency.

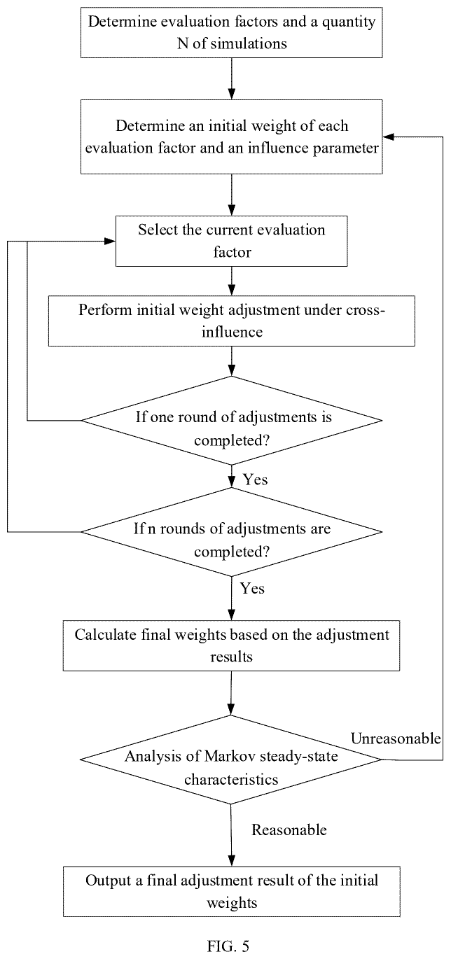

During specific implementation, as for the above another way, as shown in FIG. 5, a schematic flow chart of a plurality of rounds of adjustments for an initial weight is shown. As shown in FIG. 5, specifically, the initial weights of the plurality of evaluation factors may be adjusted in sequence. When adjusting one evaluation factor each time, initial weights of other evaluation factors that have an association relationship with this evaluation factor are adjusted based on a random number corresponding to this evaluation factor.

Next, the step of adjusting the initial weights of the plurality of evaluation factors in a plurality of rounds is repeated to obtain the adjusted initial weights respectively corresponding to the plurality of evaluation factors in the plurality of rounds of adjustments.

Then, the evaluation parameters respectively corresponding to the plurality of preset dimensions are acquired based on the adjusted initial weights respectively corresponding to the plurality of evaluation factors in the plurality of rounds of adjustments.

In each round of adjustments, the plurality of evaluation factors are adjusted in sequence. Assuming that there are twenty-three evaluation factors, twenty-three adjustments will be made. When adjusting each time, the initial weights of other evaluation factors that have an association relationship with the current evaluation factor may be adjusted according to the initial weight of the current evaluation factor and a value of the random number.

Assuming that the current evaluation factor to be compared with the random number is a third evaluation factor, if an initial weight of a fourth evaluation factor associated with the third evaluation factor needs to be adjusted when adjusting the third evaluation factor, an initial weight of the fourth evaluation factor after the previous adjustment may be adjusted, wherein the current initial weight of the third evaluation factor is also an initial weight after the previous adjustment thereof.

Exemplarily, the third evaluation factor is an evaluation factor A, an initial weight of the evaluation factor A is 0.5, and evaluation factors associated with the evaluator factor A are B and C. In the previous adjustment of the current round of adjustments, the initial weight of the evaluation factor A is adjusted from 0.5 to 0.47, and its adjustment to 0.47 is due to the adjustment of other evaluation factors that have an influence on the evaluation factor A. Then, in this adjustment, a random number may be compared with 0.47. Next, in a case that it is determined that the associated evaluation factors B and C need to be adjusted according to a comparison result, the initial weights of the evaluation factors B and C after the previous adjustment are adjusted.

The next round of adjustments may be performed after the adjustment of the plurality of evaluation factors. It should be noted that in the next round of adjustments, the initial weight of each evaluation factor is adjusted, that is, each round of adjustments is performed from an initial state. Exemplarily, after the first round of adjustments, the initial weight of the evaluation factor A is 0.45, the initial weight will return to the initial 0.5 in the next round of adjustments, and the next round of adjustments will begin.

As shown in FIG. 5, in the process of adjusting the initial weights of other evaluation factors that have an association relationship with this evaluation factor based on a random number corresponding to this evaluation factor, the initial weights of the other evaluation factors may be adjusted in a case that the initial weight of this evaluation factor is greater than the random number; and the initial weights of the other evaluation factors after the previous adjustment are retained in a case that the initial weight of this evaluation factor is not greater than the random number.

The random number may be understood as an initial weight generated randomly, which actually characterizes a random occurrence probability of an event corresponding to the evaluation factor. In a case that the initial weight of the evaluation factor is greater than the random number, the event characterized by this evaluation factor will occur, which will influence events corresponding to the other evaluation factors, so the initial weights of the other evaluation factors need to be adjusted; and in a case that the initial weight of the evaluation factor is not greater than the random number, the event characterized by this evaluation factor will not occur, which will not influence events corresponding to the other evaluation factors, so the current initial weights of the other evaluation factors may be kept unchanged.

As shown in FIG. 5, in some examples, the initial weights of other evaluation factors that have an association relationship with this evaluation factor may be adjusted based on the influence parameter of this evaluation factor, which may specifically refer to the process as shown in FIG. 4. During specific implementation, when adjusting the initial weights of the evaluation factors that have an association relationship with this evaluation factor based on the random number corresponding to this evaluation factor, the influence parameters of this evaluation factor on the evaluation factors that have an association relationship with this evaluation factor may be determined, and the initial weights of the evaluation factors that have an association relationship with this evaluation factor may be adjusted based on the influence parameters.

As described the above embodiments, the influence parameter may characterize an influence degree of the occurrence of an event characterized by an evaluation factor on the occurrence of an event characterized by another evaluation factor, and includes an influence magnitude and an influence direction. The specific adjustment process may be performed with reference to a formula (3).

Exemplarily, as shown in FIG. 5, an illustrative description of the adjustment of the initial weight in this way is as follows.
a. firstly, a quantity N of simulations is determined to indicate that N rounds of adjustments are required, N is an integer greater than 1; and then the initial weight of each evaluation factor and the influence parameters between the evaluation factors need to be determined.

At the beginning of the first round of adjustments, an evaluation factor Di is randomly selected from n evaluation factors to start a simulation calculation, n is a positive integer greater than or equal to 1, and N and n are different numerical values.
b. a random number generator or random number table is configured to acquire a random number, and compare this random number with an initial weight of Di to determine whether this Di has occurred. In response to the simulation result indicating that this Di has not occurred, the initial weights of the remaining evaluation factors remain unchanged; and in response to the simulation result indicating that this Di has occurred, initial weights of evaluation factors associated with this Di are adjusted according to the aforesaid formula (3).
c. an evaluation factor Dj is randomly selected from the remaining unextracted evaluation factors, and the newly acquired random number is compared with an initial weight of this Dj. It should be noted that if the initial weight of this Dj has been adjusted, the adjusted initial weight needs to be used, and the step b is repeated. If this Dj has occurred, initial weights of evaluation factors associated with this Dj are adjusted.
d. the above simulation process is continued until n evaluation factors all have been extracted once, and this process called a round of adjustments. In a round of adjustments, each evaluation factor has an adjusted weight due to the mutual influences from other evaluation factors.
e. the initial weights of all evaluation factors are restored to an initial state, and the next round of adjustments starts from the step a. After several rounds, e.g., 1000 rounds or more, the weights of each evaluation factor after a plurality of rounds of adjustments are counted, and the obtained result is a final weight of each evaluation factor under the effect of cross influences.

Correspondingly, in the way of a plurality of rounds of adjustments, the adjusted initial weight is obtained after each round of adjustments, so after the plurality of rounds of adjustments, each evaluation factor has a plurality of adjusted initial weights. In practice, for an evaluation factor, an average of the plurality of adjusted initial weights may be used as the final adjusted weight for this evaluation factor. Next, the final evaluation parameter of each evaluation factor may be determined according to the initial weight finally obtained by this evaluation factor.

In some examples, in order to ensure the accuracy of the evaluation parameters, a Markov chain steady state may be used to solve an initial weight in the steady state, and the initial weight in the steady state may be used as the evaluation parameter corresponding to the evaluation factor.

During specific implementation, referring to FIG. 6, a schematic flowchart of a step of solving evaluation parameters in the case of the plurality of rounds of adjustments is shown. As shown in FIG. 6, the following specific steps S601 to S603 may be included.
Step S601: constructing a cross-influence probability matrix based on the influence parameters between the evaluation factors that have an association relationship.
Step S602: performing a plurality of iteration presetting operations on the cross-influence probability matrix and the adjusted initial weights respectively corresponding to the plurality of evaluation factors in the plurality of rounds of adjustments until a preset end condition is reached.
Step S603: acquiring the evaluation parameters respectively corresponding to the plurality of preset dimensions based on the cross-influence probability matrix when the preset end condition is reached.

In step S601, there is an influence parameter between the evaluation factors that have an association relationship, and the setting of this influence parameter may be shown in FIG. 3. In practice, the cross-influence probability matrix may be constructed according to the influence parameters between the evaluation factors that have an association relationship, and each value in the cross-influence probability matrix characterizes an influence degree between the evaluation factor Di and the evaluation factor Dj. The cross-influence probability matrix may refer to the above adjacency matrix A, but is different from the adjacency matrix A in that each value in the cross-influence probability matrix is the corresponding influence parameter.

In step S602, it is possible to iteratively perform a plurality of preset operations on the cross-influence probability matrix and the final initial weights of the respective evaluation factors. This preset operation may be a matrix multiplication operation. That is, the final initial weights of the plurality of respective evaluation factors may be regarded as a one-dimensional matrix, which may be multiplied by a plurality of iterations with the cross-influence probability matrix until a preset end condition is reached.

The preset end condition may mean that the cross-influence probability matrix is multiplied by the final initial weights of the plurality of respective evaluation factors for a sufficient quantity of iterations, and each row has an equal value, wherein the one-dimensional matrix used for the next multiplication is a one-dimensional matrix obtained by previous multiplication with the cross-influence probability matrix. Specifically, it may refer to the following formula (4):

$$π = {π}_{0} {P}^{n} = {π}_{0} {P}^{n + 1} = {π}_{0} {P}^{n + 2} \qquad formula ( 4 )$$

in which: n is a positive integer greater than or equal to 1; π₀ is a one-dimensional matrix composed of the final initial weights of the plurality of respective evaluation factors; P is the cross-influence probability matrix; and π is the Markov steady state.

As shown in the formula (4), in the first multiplication, the final initial weights of the plurality of respective evaluation factors are multiplied by the cross-influence probability matrix, and the multiplication result is a one-dimensional matrix, which is denoted as π₀P¹; next, this one-dimensional matrix π₀P¹ is multiplied by its cross-influence probability matrix p to obtain another three-dimensional matrix π₀P²; and then, π₀P² is multiplied by p to obtain π₀P⁸. By repeating this process, as the above formula (4) is satisfied, the preset end condition is reached, the operation is ended subsequently, and a one-dimensional matrix π₀Pⁿ at the end of operation is saved. This one-dimensional matrix π₀Pⁿ is an initial weight distribution that finally reaches a steady state characteristic of the Markov chain.

Finally, the initial weight distribution of the steady state characteristic of the Markov chain may be converted into a 100-point system score. The Markov chain steady state refers to a non-periodic Markov chain which has a transition probability matrix P and any two connected states. After enough iterations, there is a steady state. That is, the two matrices are self-multiplied for enough times and each row has an equal value.

In some embodiments, if the preset end condition is still not reached after self-multiplication for enough times, the initial weight of each evaluation factor may be restored to an initially set initial weight, and the initial weight may be adjusted again for a plurality of rounds. That is, the process shown in FIG. 5 is repeated to obtain the final weight of each evaluation factor, and then the steady state characteristic of the Markov chain is calculated until the steady state characteristic of the Markov chain is reached.

By adopting this embodiment, a plurality of rounds of adjustments is performed in the course of adjusting the initial weight of the evaluation factor, such that the adjustment accuracy and stability of the initial weight may be improved under the condition that the evaluation factors are influenced mutually, thereby improving the accuracy of the evaluation parameters.

As mentioned above, the evaluation parameter may be a 100-point system numerical value of the final initial weight of the evaluation factor. By means of the above embodiment, the evaluation parameter corresponding to each evaluation factor may be obtained. Since one preset dimension corresponds to one evaluation factor, the evaluation parameter corresponding to the evaluation factor is the evaluation parameter corresponding to the preset dimension. As mentioned above, this evaluation parameter may be understood as a benchmark score of the preset dimension in which the evaluation factor is located. In this way, according to the dimension information of this preset dimension, a quantified score value of this preset dimension is obtained by deducting on the basis of the benchmark score. Therefore, a sum of quantified score values of a plurality of preset dimensions may be used as the basis for determining the grading parameters.

Exemplarily, taking fire safety evaluation as an example, referring to Table 6 below, Table 6 shows a schematic table of the determined adjusted initial weights of the respective evaluation factors and evaluation parameters.

It should be noted that Table 6 may be stored and used as the evaluation parameters of different physical areas on the target business. That is, a plurality of physical areas may share the same set of evaluation parameters for the target business to evaluate their grades on the target business.

Table 6 is illustrative only and does not represent a limitation on the present disclosure. In practice, the evaluation parameters may also be formulated under the standards of other point systems, such as sixty points, eighty points, and fifty points. In practice, the evaluation parameters may be set according to the needs of users. It should be pointed out that the 100-point system means that a sum of the evaluation parameters of all evaluation factors is 100.

The corrected weights in Table 6 are the adjusted initial weights in the present disclosure, which are adjusted by the influence parameters.

TABLE 6
Adjusted initial weights and evaluation parameters
for the respective evaluation factors

| | Initial | Corrected | Evaluation |
|---|---|---|---|
| Evaluation factor | weight | weight | parameter |
| A building fire zone is kept in line | 0.05 | 0.0317 | 3 |
| with the fire protection standards | | | |
| The second decoration inside the | 0.03 | 0.0155 | 2 |
| building are in line with the | | | |
| fire protection standards | | | |
| The functional nature of the building | 0.03 | 0.0203 | 2 |
| floors is in line with an original | | | |
| design | | | |
| Building safety evacuation passages, | 0.04 | 0.0272 | 3 |
| stairs, exits and refuge floors | | | |
| (walkways) are kept in line with the | | | |
| fire protection standards | | | |
| Fire water supply facility | 0.10 | 0.0740 | 7 |
| Fire hydrant system | 0.08 | 0.0698 | 7 |
| Automatic sprinkler system | 0.08 | 0.0748 | 7 |
| Automatic fire alarm system | 0.05 | 0.0754 | 8 |
| Electrical fire monitoring system | 0.04 | 0.0450 | 5 |
| Combustible gas detection system | 0.05 | 0.0495 | 5 |
| Building legality | 0.03 | 0.0135 | 1 |
| Implementation of the fire safety | 0.04 | 0.0203 | 2 |
| responsibility system | | | |
| Formulation of fire safety system and | 0.02 | 0.0114 | 1 |
| operating procedures | | | |
| Fire management organization | 0.02 | 0.0128 | 1 |
| Daily fire patrol and fire safety | 0.04 | 0.0393 | 4 |
| inspection | | | |
| Fire hazard rectification | 0.04 | 0.0796 | 8 |
| Fire control room management | 0.04 | 0.0426 | 4 |
| Maintenance of fire-fighting facilities | 0.04 | 0.0771 | 8 |
| Employee fire safety education and | 0.02 | 0.0074 | 1 |
| training | | | |
| Fire extinguishing and emergency | 0.02 | 0.0537 | 5 |
| evacuation plan | | | |
| Fire drills | 0.02 | 0.0510 | 5 |
| Miniature fire station management | 0.02 | 0.0287 | 3 |
| Fire occurrence | 0.10 | 0.0792 | 8 |

It should be noted that Table 6 may be stored and used as the evaluation parameters of different physical areas on the target business. That is, a plurality of physical areas may share the same set of evaluation parameters for the target business to evaluate their grades on the target business.

Specifically, a plurality of dimension information may be quantified first to obtain the corresponding quantified value of each dimension information; and the quantified score values respectively corresponding to the plurality of evaluation factors may be determined based on a plurality of evaluation parameters and a plurality of quantified values, and then grading parameters may be determined based on the quantified score values.

The quantization may refer to the conversion of dimension information into a numerical value, that is, the conversion of the dimension information into numerical information. Specifically, the dimension information includes text information, which may be quantified according to a conversion relationship between a plurality of preset text words and numerical values. For example, the dimension information contains state information of ventilation facilities, and the state information are codes for characterizing a good ventilation condition. Then, the codes may be converted into corresponding numerical values according to the numerical values corresponding to the good ventilation condition, so as to realize the quantification. For example, the dimension information is measure description information of measures taken by the target business. In the course of inputting this business information, the user may be asked to input numerical information, for example, how many fire drills have been held, so that numerical values may be directly extracted from this dimension information and quantified.

The quantified value may be a value of 0 to 1, including 0 and 1. In response to the dimension information being numerical numbers, the numerical numbers may be normalized to obtain a quantized value between 0 and 1. For example, when the numerical numbers are extracted from the dimension information, the numerical numbers may be normalized.

In the course of determining the quantified score values respectively corresponding to the plurality of evaluation factors based on the plurality of evaluation parameters and the plurality of quantified values, for each preset dimension, a quantified score value may be obtained by performing an operation on the evaluation parameters of this preset dimension and the quantified value under this preset dimension, and this operation may be a multiplication operation. In a case that the evaluation parameter is 3 and the quantified value is 0.8, then the quantified score value is 2.4.

Therefore, according to the above process, the quantified score values respectively corresponding to the plurality of evaluation factors may be obtained; next, a sum of the quantified score values may be determined to obtain a total quantified score value; and then, a preset score interval where the total quantified score value is located may be determined, and a grading parameter corresponding to this preset score interval is taken as the grading parameter corresponding to this physical area. This grading parameter may be configured to characterize a risk grade of the physical area on the target business. The lower the risk grade is, the higher the grade of the physical area, and the lower the risk on the target business.

It may be understood that in some cases, the higher the total quantified score value is, the higher the grading parameter is and the lower the risk grade is; and the lower the total quantified score value is, the lower the grading parameter is and the higher the risk grade is.

Certainly, in some other cases, other ways of determining the grading parameters are not excluded, e.g., the higher the total quantified score value is, the lower the grading parameter is and the higher the risk grade is; and the lower the total quantified score value is, the higher the grading parameter is and the lower the risk grade is.

As shown in Table 7 below, taking fire safety evaluation as an example, grading parameters corresponding to different preset score intervals are shown.

TABLE 7
Table of grading parameters corresponding
to different preset score intervals

| | Preset | |
|---|---|---|
| Grading | score | |
| parameter | interval | Description |
| Low | 90-100 | Fire safety is normal in all aspects, with few |
| | | fire hazards and small possibility of a fire |
| Medium | 61-89 | There is a general fire hazard, with a possibility |
| | | of a fire or a certain loss after the fire occurs |
| High | 41-60 | There are many fire hazards, with a large |
| | | possibility of a fire or great harms of the fire |
| Very high | 0-40 | There is a major fire hazard, with a high |
| | | probability of a fire and significant losses |

In some embodiments, after the quantified score values respectively corresponding to the plurality of evaluation factors are obtained, according to a difference between the quantified score value of each evaluation factor and the evaluation parameter, the evaluation factor with a large difference may be determined. This evaluation factor with a large difference may be understood as an evaluation factor that has a large negative influence on the grading of the target business. In practice, it is necessary to rectify a preset dimension where this evaluation factor is located. For example, the rectification belongs to each facility under this preset dimension, so that working states of these facilities may be restored to a good level.

During specific implementation, the difference between the evaluation parameter and the corresponding quantified score value may be determined; at least one target evaluation factor may be determined from the plurality of evaluation factors based on the difference; and recommendation information corresponding to each target evaluation factor is outputted.

In some examples, the difference between the evaluation parameter and the corresponding quantified score value may refer to a difference between numerical values. Since the evaluation parameter is a benchmark score, and the quantified score value is a score value evaluated for the dimension information, the difference between the evaluation parameter and the quantified score value may reflect the effectiveness of a working state/measure of a facility belonging to the preset dimension. The greater difference characterizes the worse working state/effectiveness, and which, in practice, needs to be rectified.

The target evaluation factor may be an evaluation factor with a difference greater than or equal to a preset difference. The preset difference may be, for example, preset to 1 or 2. Each evaluation factor is a preset dimension, and recommendation information corresponding to a quantified score value being not qualified may be stored in advance for each preset dimension. After the target evaluation factor is determined, the recommendation information corresponding to this target evaluation factor may be directly acquired. Next, the recommendation information is sent to a client in the physical area, so that the client in the physical area may display this recommendation information.

In some examples, in a case that the grading parameter does not reach a preset grading parameter, it is also possible to execute: a step of determining the difference between the above evaluation parameter and the corresponding quantified score value; and a step of determining at least one target evaluation factor from the plurality of evaluation factors based on the difference, and outputting the recommendation information corresponding to each target evaluation factor. In this way, in a case that an evaluation grade of the physical area is not high, the preset dimensions that have unquantified score values may be rectified. The preset grading parameter may be preset, for example, as shown in Table 3, may be set to 80, or 85. Certainly, this is only an illustrative description, and in practice, may be set according to specific requirements of the physical area on the target business.

In some examples, the target evaluation factor may be comprehensively determined
according to the differences among the influence parameter between the evaluation factors, the quantified score values of the evaluation factors and the evaluation parameter. The larger the influence parameter is, the higher the influence degrees of this evaluation factor on other evaluation factors. If the evaluation factor with a large influence parameter, e.g., an evaluation factor exceeding a preset influence parameter, has a difference exceeding a difference threshold, this evaluation factor may be regarded as a target evaluation factor.

It should be noted that when the target evaluation factor is jointly determined based on the influence parameters and differences, the difference threshold may be less than the above-mentioned preset difference, that is, less than a benchmark difference on which the target evaluation factor is determined solely based on the difference.

Correspondingly, in some other embodiments, in a case that the grading parameter is lower than the preset grading parameter, it is generally necessary to rectify the physical area in time. In this case, the information collection device under the preset dimension may be controlled to output an alarm, so as to carry out on-site alarm and rectification for unqualified facilities in a targeted manner, thereby improving an automation level of physical area control.

During specific implementation, in a case that the grading parameter is lower than a preset grading parameter, it is determined that the difference between the quantified score value and the evaluation parameter is greater than a target preset dimension of a preset difference, and control a target information collection device to output alarm information.

The target information collection device is configured to collect business information of the target preset dimension.

Specifically, each business information may correspond to one information collection device, and the information collection device may be a sensor, a computer, a camera, a tablet computer, etc. The computer and the tablet computer may be configured to input information related to measures taken to carry out the target business. An alarm module may be configured for the target information collection device of a sensor type, and this alarm module may be an audible and visual alarm, such as a buzzer.

In practice, the information processing platform may send an alarm instruction to the target information collection device, and the target information collection device may generate an alarm (e.g., beeps) after receiving the alarm instruction.

It should be noted that, taking fire safety evaluation as an example, alarm information outputted by the target information collection device may be different from a warning used in fire protection, so as to avoid the user's misunderstanding for the alarm, so that a fire alarm and a rectification alarm of the present disclosure may be accurately distinguished.

By adopting this embodiment, an alarm is automatically given to facilities in a preset dimension that are evaluated to be unqualified or less qualified in the physical area according to the grading parameters, so as to inform construction personnel to rectify and maintain in time and eliminate hazards, thereby avoiding an occurrence risk of the physical area on the target business.

In some other embodiments, it is generally necessary to continuously detect the state of the physical area on the target business. For example, in the fire safety evaluation, the fire safety of the building needs to be evaluated periodically; and then, in each evaluation, the method of the above embodiment may be adopted to obtain a grading parameter. In this way, the corresponding grading parameters of the physical area in a plurality of time periods may be acquired; and grading statistical information of the physical area is outputted based on the corresponding grading parameters in the plurality of different time periods to indicate grading changes of the physical area in different time periods in the target business.

The time periods in this embodiment need to be distinguished from a preset time period in the described evaluation for the target business. That is, the time periods in this embodiment are directed to the grading determination of the same grading objective in the target business, and the corresponding grading parameters corresponding to the plurality of different time periods are the corresponding grading parameters directed to the same grading objective. In this way, grading statistics may be performed on the same benchmark.

Certainly, furthermore, in a case of obtaining the quantified score value corresponding to each evaluation factor, since the evaluation parameter of the evaluation factor may remain unchanged for a certain period, a change in the quantified score value corresponding to the evaluation factor may reflect a change in a state of a facility in the physical area and the continuity of implementation measures. Therefore, evaluation factor statistical information may be generated to reflect a change in the quantified score value corresponding to each evaluation factor. Like the above grading statistical information, this evaluation factor statistical information may be in the form of a chart, e.g., a bar chart, a pie chart, a line chart, or a heat map.

In practice, the continuous control for the physical area on the target business may be monitored based on the grading statistical information and evaluation factor statistical information, so as to obtain a weak dimension of the physical area on the target business, thereby performing targeted rectification on the weak dimension.

The technical solution adopted by the embodiments of the present disclosure has the following advantages.
1. By constructing the association relationship between the plurality of evaluation factors, an interpretation model for the influence factors that influence the evaluation of the physical area on the target business is accurately depicted, which makes the hierarchy of the evaluation factors clearer and more intuitive, thereby improving the scoring accuracy.
2. The set initial weights are adjusted through the influence parameters between the evaluation factors that have an association relationship. In this process, the initial weights may also be corrected based on a Markov chain to obtain a quantified analysis result of the evaluation factors, which provides a more accurate evaluation basis for the quantified evaluation of the target business.
3. The physical area is evaluated based on actual business information of the physical area and the evaluation parameters of the evaluation factors, and a real-time feedback result from the information collection device in the physical area may be controlled according to an evaluation result, which may improve the automation level and enhance the real-time performance in controlling the physical area, thereby facilitating the physical area to eliminate hazards in time and improving the security of the physical area on the target business.

The following is an illustrative description of an information processing method of the present disclosure in combination with specific examples.

As shown in FIG. 1, taking fire safety evaluation as an example, the method includes the following steps S1 to S6.
In S1: a plurality of evaluation factors for building fire protection are determined first.

Specifically, fire safety-related evaluation factors may be acquired from a database. The plurality of evaluation factors may be divided into four categories with a total of twenty-three factors, which may be specifically as follows.

The first category: building fire management, with a main evaluation index indicating whether there is a change in a building fire protection facility approved by the statutory approval, including the following evaluation factors: a building fire resistance grade, decoration, an amount of combustibles, an unobstructed safety exit, and an unobstructed evacuation passage, which are as shown in D1-D4 of Table 1.

The second category: fire protection facility device management, with main evaluation factors including a device integrity and efficiency rate and device failure, specifically referring to: whether devices for automatic fire alarm, automatic sprinkling for fire extinguishing, fire hydrant, smoke prevention, emergency lighting and other fire protection systems are intact and effective, whether fire protection maintenance is completed as planned, etc., and the included evaluation factors being shown in D5-D10 of Table 1.

The third category: daily fire management, with main indexes indicating whether the work is completed as required, and whether the daily management responsibilities are implemented in place. For example, the evaluation factors included in management requirements for a fire control room; the completion of fire inspection and patrol; the quantity of fire hazards and the timeliness of rectification; the fire protection education and training of all employees, and the passing of the examination; the complete staffing of a miniature fire station with complete facilities; the normal daily duty, daily training, fire extinguishing and rescue drills; the rapid disposal of the fire, the fire control in the initial stage, and the large loss caused by the expansion of the fire, etc., are shown in D11-D22 of Table 1.

The fourth category: fire occurrence, wherein initial parameters are set by experts in the industry with reference to local standards, a fire safety level is determined according to the historical occurrence of fires, and the included evaluation factor is as shown in D23 of Table 1.
In S2: an association relationship between the evaluation factors, e.g., a risk evaluation factor interpretation model shown in FIG. 3, is constructed.

A connection relationship between the evaluation factors may be received. This connection relationship may indicate an interaction relationship between the evaluation factors. Specifically, the connection relationship may be given by an expert.

According to the above connection relationship between the evaluation factors, this connection relationship may reflect a direct influence relationship between the evaluation factors, as shown in Table 1 above.

Further, an association matrix (adjacency matrix) between the evaluation factors is obtained. The association matrix is subjected to a power operation according to the Boolean algebra. A reachable matrix M is obtained after several iterations.

$$A = {( {D}_{ij} )}_{23 \times 23} \{ \begin{matrix}{D}_{ij} = 1 , indicating a direct influence of {D}_{i} on {D}_{j} \\ {D}_{ij} = 0 , indicating no direct influence of {D}_{i} on {D}_{j}\end{matrix}$$

$$M = {( A + I )}^{n + 1} = {( A + I )}^{n} \neq {( A + I )}^{n - 1} ( I is a unit matrix ) .$$

An analytical hierarchy process of hazard factors is performed based on the reachable matrix, and a reachable set and a leading set (antecedent set) are used. The reachable set includes direct and indirect association relationships between the evaluation factors, and the leading set includes evaluation factors that have a positive and direct influence on an evaluation factor. For example, the occurrence of an evaluation factor A may lead to the occurrence of an event characterized by an evaluation factor B, and the evaluation factor A is assigned to the leading set.

An interpretation structure model of all factors is constructed based on the above-mentioned reachable set and leading set.

The hierarchical division process is as follows: firstly, finding top-grade elements that meet the above conditions according to the reachable matrix M, and withdrawing these elements from the reachable matrix; and then, finding top-grade elements in a new matrix, so that the evaluation factors may be divided in hierarchies by means of such cumulative progression. The interpretation structure model constructed in this example is shown in FIG. 3.
In S3: the interpretation structure model is outputted, and then initial weights and influence parameters inputted for respective evaluation factors in the interpretation structure model are received.

The influence parameters of the respective evaluation factors may be shown in FIG. 4b, and values of the initial weights may be shown in Table 3 above.

It may be understood that according to a fire occurrence mechanism, the evaluation factors may be divided into three categories: direct factors, indirect factors, and deep factors.

The direct factors are direct factors that may lead to the occurrence of a fire accident, e.g.: fire zones, facility integrity, and fire hazards.

The indirect factors refer to a reduction in a potential possibility of fire from the source, such as: whether the secondary decoration meets the standards, the implementation of a fire safety responsibility system, a fire safety system and operating procedures, fire drills, and miniature fire station management.

The deep factors lie in improving the fire safety awareness of unit personnel, such as: the building legality, whether a fire extinguishing and emergency evacuation plan is prepared, and whether employees regularly conduct fire protection knowledge training.

In this way, after the interpretation structure model is constructed, a deeper logical association between the evaluation factors may be depicted, thereby accurately obtaining evaluation parameters.
In S4: the evaluation parameters of the evaluation factors are calculated.

Due to a mutual influence relationship between events (events characterized by the evaluation factors), in order to accurately obtain the evaluation parameters, the initial weights of the evaluation factors may be adjusted for a plurality of rounds based on the influence parameters, including the following steps a to f.
In step a: an evaluation factor is randomly selected from n evaluation factors to start a simulation calculation.
In step b: a random number is acquired by using a random number generator or random number table, compared with an initial weight of the randomly selected evaluation factor Dᵢ, and whether an event of this evaluation factor Dᵢ has occurred is determined. In response to the simulation result indicating that this event has not occurred, the initial weights of the remaining evaluation factors remain unchanged; and in response to the simulation result indicating that this event has occurred, initial weights of the remaining evaluation factors are adjusted according to a formula (1). The remaining evaluation factors refer to evaluation factors that have an association relationship with the evaluation factor Dᵢ.
In step c: an evaluation factor is randomly selected from the remaining unextracted evaluation factors, a newly acquired random number is compared with an initial weight of this evaluation factor (if the initial weight of this event has been adjusted, the adjusted initial weight needs to be used), and the step b is repeated. If this event has occurred, the initial weights of other evaluation factors are adjusted and calculated according to the formula (1).
In step d: the above simulation process is continued until n evaluation factors have been extracted once, wherein this process called a round of simulations. In a round of simulations, each evaluation factor has a result of “Occurred” or “Not occurred” due to the mutual influences from other evaluation factors.
In step e: the initial weights of all evaluation factors are restored to an initial state, and the next round of simulations starts from the step a. After several rounds (e.g., 1000 rounds or more), the final initial weight of each evaluation factor is counted.
In step f: the initial weights of the twenty-three evaluation factors are corrected based on a steady state characteristic of a Markov chain to obtain a transition probability matrix P, wherein after enough iterations of this transition probability matrix P, there is a steady state, that is, after the probability transition matrix is self-multiplied for enough times, each row has an equal value. Finally, the transition probability matrix when the steady state is reached is used as the adjusted initial weights respectively corresponding to the evaluation factors.
In S5: a grade of a designated physical building on fire safety evaluation business is determined.

Through a fire protection Internet of Things platform, people, things, articles and other business information for fire management, that is, the plurality of business information described in the present disclosure, are acquired.

The business information is clustered according to the evaluation factors to obtain a plurality of dimension information; then, each dimension information is quantified to obtain a quantified value; and next, based on the evaluation parameters, as shown in Table 3 above, the evaluation parameters are scores obtained after multiplying the initial weight by 100, and the scores are calculated according to a deduction rule, wherein an upper deduction limit is a score of this evaluation factor.

The quantified score values corresponding to the respective evaluation factor are summed, and a grade of fire safety risk is determined according to a score segment where a total score obtained by summing is located.
In S6: rectification and processing items are recommended.

Key unqualified items are explained for rectification comments according to scores in S5 and in conjunction with the influence degrees of the evaluation factors.

For example, if a unit building is found to be kept in line with the fire protection standards through personnel patrol, three points will be deducted according to score weights; if the unit does not upload a fire extinguishing and emergency plan for archiving in the system, five points will be deducted; if a water pressure of a fire hydrant is found to be too low according to the dynamic monitoring of the fire Internet of Things platform, seven points will be deducted; and if the Internet of Things platform receives a residual current alarm (an electrical fire monitoring system), five points will be deducted. Therefore, a total score of the unit's fire safety risk evaluation=100−3−5−7−5=80 points, so the risk grade is medium. For the above four unqualified items, matching rectification comments are queried from a rectification comment database. The recommended rectification comments include: (1) clearing an evacuation passage, such that the evacuation passage keeps unobstructed and meets the fire protection standards; (2) formulating a fire extinguishing emergency plan as soon as possible and uploading it to the system for archiving; (3) checking a fire hydrant pipe network system and maintaining a normal water pressure; and (4) overhauling an electrical fire system at a corresponding point and repairing a fault.

Based on the same invention concept, the present disclosure further provides an evaluation parameter output apparatus. This apparatus may provide automatic and accurate determination of evaluation parameters for the evaluation of a physical area on target business, so as to help improve an automation level for the evaluation and control of the physical area.

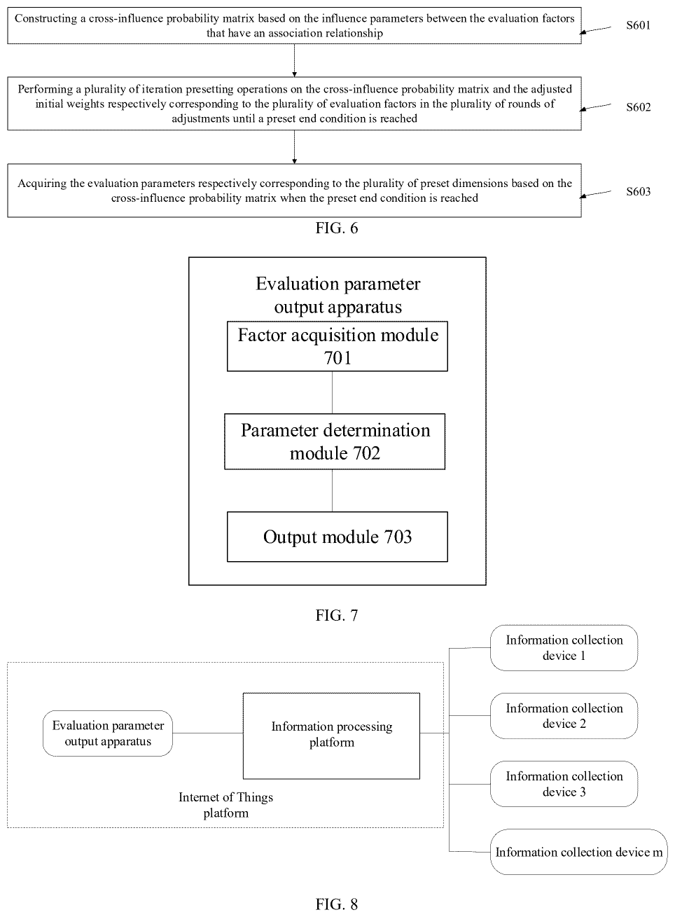

Referring to FIG. 7, a schematic diagram of a frame structure of this evaluation parameter output apparatus is shown. As shown in FIG. 7, the apparatus may be integrated into an information processing platform, or may be individually configured into an electronic device, and is in communication connection with the information processing platform through the electronic device. The apparatus may specifically include the following modules:
a factor acquisition module 701, configured to acquire a plurality of evaluation factors corresponding to the target business in the physical area, one evaluation factor corresponding to one preset dimension of the target business;
a parameter determination module 702, configured to determine the evaluation parameters respectively corresponding to the plurality of evaluation factors; and
an output module 703, configured to send the evaluation parameters to an information processing platform, such that the information processing platform determines grading parameters of the physical area on the target business based on the plurality of evaluation parameters and the plurality of dimension information, the grading parameters being configured to indicate a grade to which the physical area belongs,
the dimension information being obtained by clustering a plurality of business according to the plurality of preset dimensions, and the plurality of business information including at least state information of different facilities in the physical area.

In some examples, this parameter determination module 702 may include the following units:
a relationship construction unit, configured to construct an association relationship between the plurality of evaluation factors;
a weight acquisition unit, configured to output the association relationship and receive an initial weight inputted for each evaluation factor; and
a parameter determination unit, configured to determine the evaluation parameters respectively corresponding to the preset dimensions based on the initial weights.

The process of determining the evaluation parameters may refer to the relevant description of the above information processing method, which will not be repeated here.

In some examples, the apparatus may further include an influence parameter determination module and an adjustment module, wherein
the influence parameter determination module is configured to receive an influence parameter inputted for evaluation factors that have an association relationship, the influence parameter being configured to characterize an influence degree of the occurrence of an event characterized by an evaluation factor on the occurrence of an event characterized by another evaluation factor;
the adjustment module is configured to adjust initial weights of the respective evaluation factors based on the influence parameters; and
the parameter determination unit is specifically configured to determine the evaluation parameters respectively corresponding to the preset dimensions based on the adjusted initial weights.

The process of determining the evaluation parameters may refer to the relevant description of the above information processing method, which will not be repeated here.

In some examples, the apparatus may further include an iteration adjustment module;
the iteration adjustment module is configured to adjust the initial weights of the plurality of evaluation factors in sequence, in the event of each adjustment of one evaluation factor, an initial weight of an evaluation factor that has an association relationship with the evaluation factor being adjusted based on a random number corresponding to the evaluation factor, wherein
in the course of adjusting initial weights of other evaluation factors that have an association relationship with this evaluation factor, the influence parameter determination module and the adjustment module are configured to adjust the initial weights of the evaluation factors; and
the parameter determination unit is specifically configured to acquire evaluation parameters respectively corresponding to the plurality of preset dimensions based on the adjusted initial weights respectively corresponding to the plurality of evaluation factors in a plurality of rounds of adjustments.

The process of determining the evaluation parameters may refer to the relevant description of the above information processing method, which will not be repeated here.

In some examples, the factor acquisition module is configured to acquire a plurality of evaluation factors from a database corresponding to the target business and construct an association relationship between the plurality of evaluation factors.

The process of constructing the association relationship between the plurality of evaluation factors may refer to the relevant description of the above information processing method, which will not be repeated here.

In some examples, the information processing platform may be an Internet of Things platform, this output apparatus may be integrated into the information processing platform, or the information processing platform and the output apparatus may be integrated into the Internet of Things platform.

By adopting the technical solution of the embodiments of the present disclosure, the evaluation parameter output apparatus may provide the evaluation parameters of the evaluation factors for a plurality of target business. It may be understood that different target business may have different evaluation factors. For different evaluation factors, accurate evaluation parameters may still be provided to the corresponding target business through the functions of the respective modules in the evaluation parameter output apparatus, so that the information processing platform may automatically complete the grade evaluation of the physical area on the target business according to the acquired business information and the evaluation parameters, thereby assisting the automatic evaluation and automatic control of the physical area.

Based on the same invention concept, the present disclosure further provides an information processing system. This information processing system may refer to FIG. 1, and specifically includes an Internet of Things platform and a plurality of information collection devices connected to the Internet of Things platform, wherein:
the plurality of information collection devices is configured to collect business information of a physical area on target business; and
the Internet of Things platform is configured to execute the steps in the information processing method as described above.

It should be noted that, the apparatus embodiment is similar to the method embodiment, so the description is relatively simple. For related parts, please refer to the method embodiment.

Referring to FIG. 8, a schematic diagram of a frame structure of this information processing system is shown. This information processing system includes an information processing platform, an evaluation parameter output apparatus and a plurality of information processing apparatuses. FIG. 8 shows m information processing apparatuses. The information processing platform and the evaluation parameter output apparatus may be integrated into the Internet of Things platform. The evaluation parameter output apparatus is configured to provide the information processing platform with a plurality of evaluation parameters respectively corresponding to a plurality of evaluation factors in the target business. The information processing platform is configured to determine grading parameters of the physical area on the target business based on the business information collected by each information collection device acquired by the Internet of Things platform.

Based on the same invention concept, the present disclosure further provides an electronic device. The electronic device includes a memory, a processor and a computer program that is stored in the memory and operable on the processor, wherein the processor is configured to implement the information processing method in the above embodiments when executing the program.

An embodiment of the present disclosure further provides a computer-readable storage medium in which a computer program is stored that causes a processor to perform the information processing method in the embodiments of the present disclosure.

Finally, it should be noted that in this specification, relational terms such as first and second are only used to distinguish one entity or operation from another entity or operation, and do not necessarily require or imply any actual relationship or order between these entities or operations. Moreover, the terms “comprising”, “including”, or any other variation thereof are intended to encompass non-exclusive inclusion, such that a process, method, commodity, or device that includes a series of elements not only includes those elements, but also includes other elements that are not explicitly listed, or also includes elements inherent to such process, method, commodity, or device. Without further limitations, the elements limited by the statement “including one . . . ” do not exclude the existence of other identical elements in the process, method, commodity, or device that includes the said elements.

The above provides a detailed introduction to the information processing method and apparatus, the evaluation parameter output apparatus, the system and the medium provided in the present disclosure. Specific examples are applied in this specification to explain the principles and implementation methods of the present disclosure. The above examples are only used to help understand the method and its core idea disclosed in the present disclosure. Meanwhile, for persons skilled in the art, there may be changes in specific implementation methods and application scope based on the ideas disclosed in the present disclosure. In summary, the content of this specification should not be understood as a limitation on the present disclosure.

Persons skilled in the art, after considering the specification and practicing the invention disclosed herein, will easily come up with other embodiments of the present disclosure. The present disclosure aims to cover any variations, uses, or adaptive changes of the present disclosure, which follow the general principles of the present disclosure and include common knowledge or customary technical means in the technical field that are not disclosed in the present disclosure. The specification and embodiments are only considered exemplary, and the true scope and spirit of the present disclosure are indicated by the following claims.

It should be understood that the present disclosure is not limited to the precise structure described above and shown in the drawings, and various modifications and changes can be made without departing from its scope. The scope of the present disclosure is limited only by the attached claims.

The term “one embodiment,” “an embodiment,” or “one or more embodiments” referred to in this specification means that specific features, structures, or features described in conjunction with the embodiments are included in at least one embodiment disclosed herein. Furthermore, please note that the example of the term “in one embodiment” may not necessarily refer to the same embodiment.

In the specification provided here, a large number of specific details are explained. However, it can be understood that the embodiments of the present disclosure can be practiced without these specific details. In some examples, well-known methods, structures, and techniques are not shown in detail to avoid blurring the understanding of this specification.

In the claims, any reference symbol between parentheses should not be constructed as a limitation on the claims. The word “comprising” does not exclude the presence of components or steps not listed in the claims. The word “a/an” or “one” before a component does not exclude the existence of multiple such components. The present disclosure can be achieved through hardware comprising several different components and through appropriately programmed computers. Among the unit claims that list several devices, several of these devices can be specifically embodied through the same hardware item. The use of words such as first, second, and third does not indicate any order. These words can be interpreted as names.

Finally, it should be noted that the above embodiments are only used to illustrate the technical solution of the present disclosure, and not to limit it. Although detailed explanations of the present disclosure have been provided with reference to the aforementioned embodiments, those skilled in the art should understand that they can still modify the technical solutions recorded in the aforementioned embodiments, or equivalently replace some of the technical features therein. And these modifications or replacements do not make the essence of the corresponding technical solutions deviate from the spirit and scope of the technical solutions of the embodiments of the present disclosure.

1. An information processing method, comprising:
acquiring a plurality of business information of a physical area on target business, wherein the plurality of business information comprises at least information configured to describe states of different facilities in the physical area;
clustering the plurality of business information according to a plurality of preset dimensions to obtain a plurality of dimension information respectively corresponding to the plurality of preset dimensions;
acquiring a plurality of evaluation parameters respectively corresponding to the plurality of preset dimensions; and
determining grading parameters of the physical area on the target business based on the plurality of evaluation parameters and the plurality of dimension information, wherein the grading parameters are configured to indicate a grade to which the physical area belongs.

2. The method according to claim 1, wherein the acquiring a plurality of evaluation parameters respectively corresponding to the plurality of preset dimensions comprises:
acquiring a plurality of evaluation factors respectively corresponding to the plurality of preset dimensions, and constructing an association relationship between the plurality of evaluation factors, wherein the association relationship comprises a direct association relationship and an indirect association relationship;
determining an initial weight of each of the plurality of evaluation factors based on the association relationship; and
determining the plurality of evaluation parameters respectively corresponding to the plurality of preset dimensions based on the initial weights.

3. The method according to claim 2, wherein the constructing an association relationship between the plurality of evaluation factors comprises:
receiving an influence relationship inputted for the plurality of evaluation factors, wherein the influence relationship is configured to characterize a direct association between the plurality of evaluation factors; and
constructing the association relationship based on the influence relationship.

4. The method according to claim 2, wherein the determining the plurality of evaluation parameters respectively corresponding to the plurality of preset dimensions based on the initial weights comprises:
determining an influence parameter of a first evaluation factor on a second evaluation factor that has an association relationship with the first evaluation factor, wherein the influence parameter is configured to characterize an influence degree of the first evaluation factor on the second evaluation factor, and the first evaluation factor is any evaluation factor among the plurality of evaluation factors;
adjusting an initial weight of the second evaluation factor based on the influence parameter; and
determining the plurality of evaluation parameters respectively corresponding to the plurality of preset dimensions based on adjusted initial weights.

5. The method according to claim 2, wherein the determining the plurality of evaluation parameters respectively corresponding to the plurality of preset dimensions based on the initial weights comprises:
adjusting the initial weights of the plurality of evaluation factors in sequence, and when adjusting one evaluation factor each time, adjusting an initial weight of an evaluation factor that has an association relationship with the one evaluation factor based on a random number corresponding to the one evaluation factor;
repeating the step of sequentially adjusting the initial weights of the plurality of evaluation factors in a plurality of rounds to obtain the adjusted initial weights respectively corresponding to the plurality of evaluation factors in the plurality of rounds of adjustments; and
acquiring the plurality of evaluation parameters respectively corresponding to the plurality of preset dimensions based on the adjusted initial weights respectively corresponding to the plurality of evaluation factors in the plurality of rounds of adjustments.

6. The method according to claim 5, wherein the adjusting an initial weight of an evaluation factor that has an association relationship with the one evaluation factor based on a random number corresponding to the one evaluation factor comprises:
in a case that the initial weight of the one evaluation factor is greater than the random number, adjusting the initial weight of the evaluation factor that has the association relationship with the one evaluation factor; and
in a case that the initial weight of the one evaluation factor is not greater than the random number, retain the initial weight of the evaluation factor that has the association relationship with the one evaluation factor after a previous adjustment.

7. The method according to claim 5, wherein the adjusting an initial weight of an evaluation factor that has an association relationship with the one evaluation factor based on a random number corresponding to the one evaluation factor comprises:
determining an influence parameter of the one evaluation factor on the evaluation factor that has an association relationship with the one evaluation factor, wherein the influence parameter is configured to characterize an influence degree of occurrence of an event characterized by an evaluation factor on occurrence of an event characterized by another evaluation factor; and
adjusting the initial weight of the evaluation factor that has the association relationship with the one evaluation factor based on the influence parameter.

8. The method according to claim 5, wherein the acquiring the plurality of evaluation parameters respectively corresponding to the plurality of preset dimensions based on the adjusted initial weights respectively corresponding to the plurality of evaluation factors in the plurality of rounds of adjustments comprises:
constructing a cross-influence probability matrix based on the influence parameters between the evaluation factors that have the association relationship;
performing a plurality of iteration presetting operations on the cross-influence probability matrix and the adjusted initial weights respectively corresponding to the plurality of evaluation factors in the plurality of rounds of adjustments until a preset end condition is reached; and
acquiring the evaluation parameters respectively corresponding to the plurality of preset dimensions based on the cross-influence probability matrix when the preset end condition is reached.

9. The method according to claim 1, wherein the determining grading parameters of the physical area on the target business based on the plurality of evaluation parameters and the plurality of dimension information comprises:
quantifying the plurality of dimension information to obtain a quantified value corresponding to each dimension information;
determining quantified score values respectively corresponding to the plurality of evaluation factors based on the plurality of evaluation parameters and the plurality of quantified values; and
determining the grading parameters based on the quantified score values.

10. The method according to claim 9, wherein after determining the quantified score values respectively corresponding to the plurality of evaluation factors based on the plurality of evaluation parameters and the plurality of quantified values, the method further comprises:
determining differences between the evaluation parameters and the corresponding quantified score values;
determining at least one target evaluation factor from the plurality of evaluation factors based on the differences; and
outputting recommendation information corresponding to each of the at least one target evaluation factor.

11. The method according to claim 9, wherein the plurality of business information is derived from a plurality of information collection devices, and the method further comprises:
in a case that the grading parameter being lower than a preset grading parameter, determining that the difference between the quantified score value and the evaluation parameter is greater than a target preset dimension of a preset difference; and
controlling a target information collection device to output alarm information, wherein the target information collection device is configured to collect business information of the target preset dimension.

12. The method according to claim 1, further comprising:
acquiring corresponding grading parameters of the physical area in a plurality of different time periods; and
outputting grading statistical information of the physical area based on the corresponding grading parameters in the plurality of different time periods to indicate grading changes of the physical area in different time periods in the target business.

13. The method according to claim 1, wherein the acquiring a plurality of business information of a physical area on target business comprises:
when a preset time period arrives, in response to a grading objective of the preset time period, acquiring business information of the physical area corresponding to the grading objective in the target business, wherein the grading objectives corresponding to the different preset time periods are the same or different; and
the plurality of preset dimensions correspond to the grading objectives.

14. The method according to claim 1, wherein the acquiring a plurality of business information of an entity area in target business comprises:
sending an information collection instruction to the plurality of information collection devices located in the physical area to indicate the information collection devices to collect facility states of facilities with which the information collection devices are configured; and
acquiring business information collected after the information collection performed by the plurality of information collection devices.

15. An information processing system, comprising an Internet of Things platform and a plurality of information collection devices connected to the Internet of Things platform, wherein:
the plurality of information collection devices is configured to collect business information of a physical area on target business; and
the Internet of Things platform is configured to execute the information processing method according to claim 1.

16-19. (canceled)

20. A non-transitory computer-readable storage medium, wherein a computer program stored therein causes a processor to perform the information processing method according to claim 1.

21. The system according to claim 15, wherein the acquiring a plurality of evaluation parameters respectively corresponding to the plurality of preset dimensions comprises:
acquiring a plurality of evaluation factors respectively corresponding to the plurality of preset dimensions, and constructing an association relationship between the plurality of evaluation factors, wherein the association relationship comprises a direct association relationship and an indirect association relationship;
determining an initial weight of each of the plurality of evaluation factors based on the association relationship; and
determining the plurality of evaluation parameters respectively corresponding to the plurality of preset dimensions based on the initial weights.

22. The system according to claim 21, wherein the constructing an association relationship between the plurality of evaluation factors comprises:
receiving an influence relationship inputted for the plurality of evaluation factors, wherein the influence relationship is configured to characterize a direct association between the plurality of evaluation factors; and
constructing the association relationship based on the influence relationship.

23. The system according to claim 21, wherein the determining the plurality of evaluation parameters respectively corresponding to the plurality of preset dimensions based on the initial weights comprises:
determining an influence parameter of a first evaluation factor on a second evaluation factor that has an association relationship with the first evaluation factor, wherein the influence parameter is configured to characterize an influence degree of the first evaluation factor on the second evaluation factor, and the first evaluation factor is any evaluation factor among the plurality of evaluation factors;
adjusting an initial weight of the second evaluation factor based on the influence parameter; and
determining the plurality of evaluation parameters respectively corresponding to the plurality of preset dimensions based on adjusted initial weights.

24. The system according to claim 21, wherein the determining the plurality of evaluation parameters respectively corresponding to the plurality of preset dimensions based on the initial weights comprises:
adjusting the initial weights of the plurality of evaluation factors in sequence, and when adjusting one evaluation factor each time, adjusting an initial weight of an evaluation factor that has an association relationship with the one evaluation factor based on a random number corresponding to the one evaluation factor;
repeating the step of sequentially adjusting the initial weights of the plurality of evaluation factors in a plurality of rounds to obtain the adjusted initial weights respectively corresponding to the plurality of evaluation factors in the plurality of rounds of adjustments; and
acquiring the plurality of evaluation parameters respectively corresponding to the plurality of preset dimensions based on the adjusted initial weights respectively corresponding to the plurality of evaluation factors in the plurality of rounds of adjustments.
